(19) United States
(12) Patent Application Publication
(10) Pub. No.: US 2013/0036047 A1
(43) Pub. Date: Feb. 7, 2013

(54) METHOD, SYSTEM AND PROCESS FOR CENTRALIZED MANAGEMENT AND CONTROL OF A BUDGET AND ELECTRONIC MASS DISTRIBUTION OF FUNDS

(71) Applicant: Michael Busher, Vancouver, WA (US)

(72) Inventor: Michael Busher, Vancouver, WA (US)

(73) Assignee: NXSYSTEMS, INC., Portland, OR (US)

(21) Appl. No.: 13/565,055

(22) Filed: Aug. 2, 2012

Related U.S. Application Data
(60) Provisional application No. 61/514,734, filed on Aug. 3, 2011.
(60) Provisional application No. 61/514,723, filed on Aug. 3, 2011.

(51) Int. Cl. G06Q 40/00; G06Q 40/02

(52) U.S. Cl. 705/41; 705/44

(57) ABSTRACT

A computer-implemented centralized budgeting system and method can include a central budget account containing a quantity of electronic funds housed in a computer system of a financial institution. A plurality of cards can be distributed to account holders to provide access to the funds in the central budget account. A control database can be provided and stored in a server computer system. The control database can include one or more sets of rules for controlling the approval or denial of card requests to access the funds in the central budget account. A web-interface can be provided to enable a client to establish and/or modify the one or more sets of rules for controlling the approval or denial of card requests. Secondary account holders can be provided access to the funds in the central budget account upon one or more different sets of rules than the primary account holder(s).

### PRIORITY CLAIM

This application is co-pending with and claims priority from U.S. Provisional Patent Application Ser. No. 61/514,734, filed Aug. 3, 2011, and U.S. Provisional Patent Application Ser. No. 61/514,723, filed Aug. 3, 2011, the contents of each of which are incorporated herein by reference in their entireties.

### FIELD OF THE INVENTION

The inventive concepts of this application relate generally to systems and methods for the receipt and distribution of funds. More specifically, the inventive concepts relate to a system and method for electronically managing monetary transactions and accounts and for managing the distribution of funds from one or more centralized budgeting accounts. This invention also relates to a system and method for electronically managing monetary transactions and accounts and for distributing funds from a single account to multiple recipients, including electronic mass distribution (EMD).

### BACKGROUND OF THE INVENTION

Electronic funds distribution and management is a critical part of the modern financial system. Unfortunately, conventional electronic monetary transaction and management systems and methods are severely limited in both their approach and their capabilities. Significantly, no conventional system provides a complete solution for transferring funds between parties using computing devices that can be customized to meet any criteria. Rather, current electronic funds movement systems suffer from numerous drawbacks.

For instance, although conventional systems may provide either an option to facilitate transactions for prepaid debit cards, provide electronic funds movement between financial institutions, allow users to pay bills electronically, or make or receive payments, they do not offer a comprehensive solution providing all of these options on a single platform. A specific drawback of current systems is the inability to have an account for a given user that provides different functions based upon any number of user-specified criteria. Current platforms allow the creation of an account that stores information related to that account only (for instance, such as an electronic account for a credit card, a pre-paid debit card account, or a bank account), but these platforms do not allow all of these different forms of payment vehicles to be accessed from one platform and one account.

Existing methods and systems further do not allow for the tracking of both incoming and outgoing funds, such as is needed by title companies to receive and disburse funds at a mortgage closing. Conventionally, mortgage title companies have been forced to use cashier's checks as the medium of distributing the closing funds, which provides no accountability or reporting processes to provide verification that the funds were actually distributed to the appropriate recipient.

Conventional systems also lack the ability for individuals (such as the self-employed) to have taxes removed from incoming payments, without the need for engaging expensive accountants or tax firms. And conventional systems further fail to provide budget accounts that permit real-time monitoring and control over expenses. Thus, what is needed is a platform that can accommodate all of the different electronic funds requirements and that is further capable of servicing new requirements as they arise.

### SUMMARY OF THE INVENTION

With the emergence and use of electronic funds movement to replace physical cash and checks, and with businesses operating in more than one country, entities need a platform that provides a solution for all of their funds movement requirements, including global payment abilities. To meet these requirements, principles according to the present inventive concepts provide a solution that allows multiple electronic accounts (or “subaccounts”) within a single user account, where each of those subaccounts can be configured with characteristics and rules that are specific to that subaccount and that can be separate and distinct from the rules and characteristics of the other subaccounts.

According to one aspect of the present inventive concepts, for instance, an electronic funds distribution system and method allows any entity, whether a business or individual user, to use the system for all of their funds requirements. For example, one system embodiment can be used to budget funds, pay bills, receive and distribute incoming or outgoing funds to more than one account, pay taxes, and/or exchange currency with entities in other countries. It could also be used for collecting bills, distributing payroll to employees in any country and further permit selection from any of a number of different notifications and reporting formats.

A preferred platform can also provide a “good funds” model so that overdrafts do not occur at any stage of the funds movement, and can further include rules that prohibit any activity not acceptable by the US Patriot Act or other international fraud control policies and regulations. The system could also provide fraud protection for each of the entities involved in the funds movement.

According to another aspect of the inventive concepts, a system and method can allow for the receipt and distribution of incoming and outgoing funds for title companies to receive and disburse funds at a mortgage closing. The system and method can provide a reporting process that enables verification that the funds were actually distributed to the appropriate recipient(s).

According to still another embodiment, a system and method can provide the ability for a self-employed individual to have taxes removed from incoming payments into his or her account, without engaging expensive accountants or tax firms.

Another embodiment of the present inventive concepts can provide Intercept Technology™, which enables funds coming into an account to be caught and processed according to a pre-established set of rules before the funds are deposited into the user's account.

According to another aspect of the present inventive concepts, the system and method can provide Intercept Technology™ hardware and/or software enabling funds to be captured and processed according to a predetermined set of rules before those funds are deposited into a user's account. For instance, the Intercept Technology™ hardware and/or software could be used to capture incoming funds and pay selected bills, divert funds to a savings, mortgage or other account, pay taxes, or to redirect funds in any other desired manner before those funds are deposited into the user's account. Using this system, a virtually infinite number of rules and conditions could be established by the user to determine how and when to process incoming funds.

The system can include a core platform comprising one or more software modules that run on one or more servers. These software modules can include a core database that stores account and subaccount information, along with the specific rules that govern the receipt and distribution of funds for each account and subaccount. The core system may be accessed and utilized by various different clients using additional specific rules or modules that control the type of interface and options available to that given client. The core platform can further contain numerous rules and options for each account and subaccount that can be turned on or off based on the requirements of a given user.

For example, an individual user may choose to set up a primary account with multiple subaccounts using one embodiment of the present system. The individual user may access the system using a web browser installed on his or her personal computer system. The web interface for the individual user can be configured to provide a look and feel along with specific account options that would be desirable for an individual's personal accounts. Specific account options desirable for an individual could be turned on and made accessible to an individual user, for instance, while other account options that would not be applicable to such a user could be turned off and rendered inaccessible to that user.

In one embodiment, for example, the individual user could be permitted to set up multiple subaccounts, each with different rules and capabilities. One subaccount, for instance, could be set up as a pre-paid debit card that is funded with a certain amount of money every month to provide an allowance for a college student. Another subaccount could be set up as a mortgage account that can be configured to receive a specific amount of money from each paycheck and can be further configured to use that money to electronically pay the mortgage each month. Any number of subaccounts could be set up and configured by the user to perform any desired electronic financial transactions based on the rules established by the user. Each subaccount could further be set up as any desired fund or account type (e.g., prepaid debit card, distribution account, holding account, savings account, checking account, etc.), and can be configured to automatically perform any desired electronic financial transaction in any desired currency based on the specific set of rules established by the user. As another example, for instance, a savings account could be set up to receive and retain a certain amount of money each paycheck, each month, or with each payment that comes in from any source. The power, flexibility, and added security of such a system should be apparent to those skilled in the art.

In yet another potential embodiment, an institutional user, such as a bank or other financial institution, could choose to have their own private custom application interface (API) configured for their own internal use and/or their customer use. This custom API could be configured based on the specific requirements of the institution and can be configured to present itself to the consumer as a product of that institution (e.g., with the specific look, feel, trademarks, trade names, etc., of the bank or institution). The custom API could, for instance, be configured to be accessible directly over a private network or could be configured to be accessible via a web interface, such as through a web browser. All or a portion of the software for providing the custom API could be located on the institution computers or all or any portion thereof may be located on the main system servers. The custom API can further be configured to provide only those specific account options to any given user (e.g., such as an employee and/or customer) which the institution chooses to make available to that particular user or user type.

Any number and configurations of interfaces to the core system platform could be provided based on the specific needs or desires of a customer or industry. A specific application in the mortgage industry, for instance, preferably provides a mechanism for receiving, distributing, and tracking incoming and outgoing funds during a mortgage closing transaction. Any desired number of accounts and subaccounts can be set up and used to receive and track the incoming funds and to disburse the outgoing funds with the ability to easily verify payment of the outgoing funds to the appropriate entities.

Another embodiment providing comprehensive budget oversight and control, such as for the movie industry, is also contemplated. Movie budgets can be astronomical, and conventional payment methods provide no adequate ability to track and control expenditures. Using principles of the present inventive concepts, an account (i.e., a centralized budget account) can be created and funded and can include any desired number of subaccounts. The subaccounts can, for instance, be configured for a specific group, individual, or department and can provide fund access through a pre-paid debit card or any other desired electronic monetary transaction. Each of the subaccounts can be set up and funded based on any desired rules established by the account manager. In addition, any number and combination of rules can be created to control expenditures from those accounts (as well as replenishment of funds).

An account manager (and/or any other desired recipients) can further be given real-time notification of any expenditures being made, including, for instance, information regarding to whom payments are being made and what they are being made for. Comprehensive, real-time budget reports can also be enabled using this system, and a complete record and categorization of expenses can be readily obtained at any time with up-to-date information. In this manner, costs and expenses can be closely monitored and controlled with complete and accurate real-time accounting.

Similar embodiments could be used to control budgets for other industries, companies, departments, organizations, and/or other entities where budgeting, accounting, and expense control may otherwise present a problem, such as for large construction projects, for example. Using a system of subaccounts configured with the appropriately budgeted amounts and with real-time reporting and control by a project/budget manager, increased accountability can be achieved and project budgets can be more directly controlled and monitored.

In a centralized budgeting system according to another potential embodiment, rather than creating multiple subaccounts that are funded from the primary account, the money can be held in a single, centralized account and budgets to various individuals, departments, etc., can be controlled through account access cards. Each of the account access cards can, for instance, be assigned to an account holder and can be configured with any desired set of rules for controlling what purchases can be made with that account access card.

Rules for controlling budget expenditures can, for instance, include merchant, merchant type, purchase timings, velocities, discounts, or any other desired rules for controlling purchases. A budget manager can therefore maintain complete control, for example, over when, where, how much and how often purchases are made. The budgeting system can run, for example, on the Visa/MC network, and can use any one or more of their data codes for establishing the rules to control budget expenditures in real-time.

Real-time reporting and notifications can also be enabled using this system, giving the budget manager complete and accurate up-to-date information regarding the overall budget account, as well as for each of the budgets established for the individual account access cards.

Numerous other potential aspects and embodiments are also contemplated as being within the scope of the present inventive concepts and will be readily apparent to those of skill in the art based on the following detailed description.

### BRIEF SUMMARY OF THE DRAWINGS

The foregoing and additional objects and advantages of the present inventive concepts will become more readily apparent through the following detailed description, made with reference to the accompanying drawings, in which:

FIG. 1 is a schematic block diagram illustrating certain aspects of a computer-implemented system and method for facilitating electronic funds management and transfers according to various principles of the present inventive concepts, wherein the funds can preferably be captured, redirected and distributed to user-specified destination subaccounts and/or exit products for the funds before they are deposited in the user's primary account;

FIG. 2 is a schematic block diagram detailing various components and operations for capturing and distributing electronic funds transfers with complete tracking capabilities using the electronic funds management and transfer system and method of FIG. 1, according to additional features of the present inventive concepts;

FIG. 3 is a schematic block diagram illustrating program logic for establishing and implementing rules and conditions for prioritizing, performing, tracking, and logging transactions and transactional data according to still other features of the present inventive concepts;

FIG. 4 is a schematic illustration of various components of a computing system and environment that can be used to provide the system and method of FIGS. 1-3;

FIG. 5 is a schematic illustration showing one potential implementation of the system and method of FIG. 1, wherein it can be used to perform global electronic funds transactions in which funds can be electronically received and distributed using multiple entry and exit products, and further illustrating intercept and distribution capabilities (including the virtually limitless combinations of processing rules and exit products) unique to this platform for both client and provider distributions;

FIG. 6 is a schematic diagram illustrating in more detail various provider distribution capabilities according to various principles of the present inventive concepts;

FIG. 7 is a schematic diagram illustrating in more detail various client distribution capabilities according to various principles of the present inventive concepts;

FIG. 8 is yet another schematic illustration, showing an alternate implementation of the system of FIG. 1, in which the provider distribution includes a merchant payout account according to additional principles of the present inventive concepts;

FIGS. 9 and 10 are still further schematic diagrams illustrating some tracking, displaying and notification capabilities of global electronic funds bi-directional transactions according to additional features and principles of the present inventive concepts;

FIG. 11 is a schematic diagram illustrating a system and method for using the features and capabilities of the present inventive concepts to facilitate electronic funds and document transfers for a mortgage closing;

FIGS. 12-15 are various screen shots illustrating a potential interface for receiving input and information from, and communicating information with, a user of the system and method of FIG. 1 to set up and facilitate electronic funds transfers according to various principles of the present inventive concepts;

FIG. 16 is a schematic block diagram illustrating a system and method for creating and managing a centralized budget account according to still other principles of the present inventive concepts;

FIG. 17 is a flow chart illustrating a method for creating and managing a centralized budget account according to additional principles of the present inventive concepts;

FIG. 18 is a table illustrating various data codes and categories that could be used as authorization parameters for any given account holder, card, or transaction; and

FIG. 19 is a flow chart illustrating an electronic mass distribution of funds transaction according to yet another aspect and embodiment of the present inventive concepts.

### DETAILED DESCRIPTION

Various preferred aspects and embodiments of the present inventive concepts will now be described in additional detail with reference to the accompanying figures. It should be noted, however, that the following description and embodiments are provided by way of example only and not of limitation, and that many other implementations and embodiments of the present inventive concepts will be readily apparent to those skilled in the art based on the disclosure herein. The scope of the inventive concepts is therefore not limited to the particular embodiments described herein.

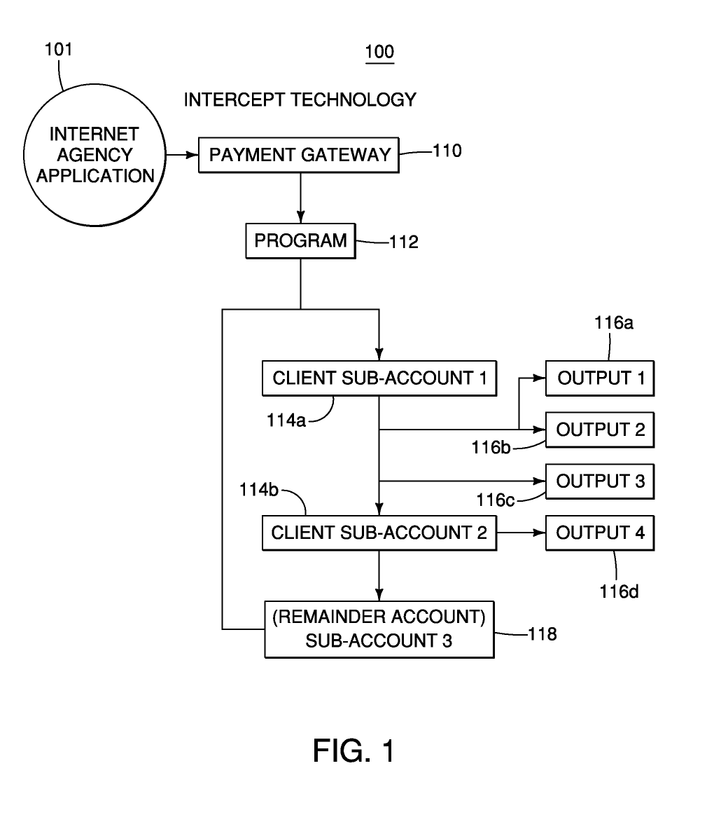

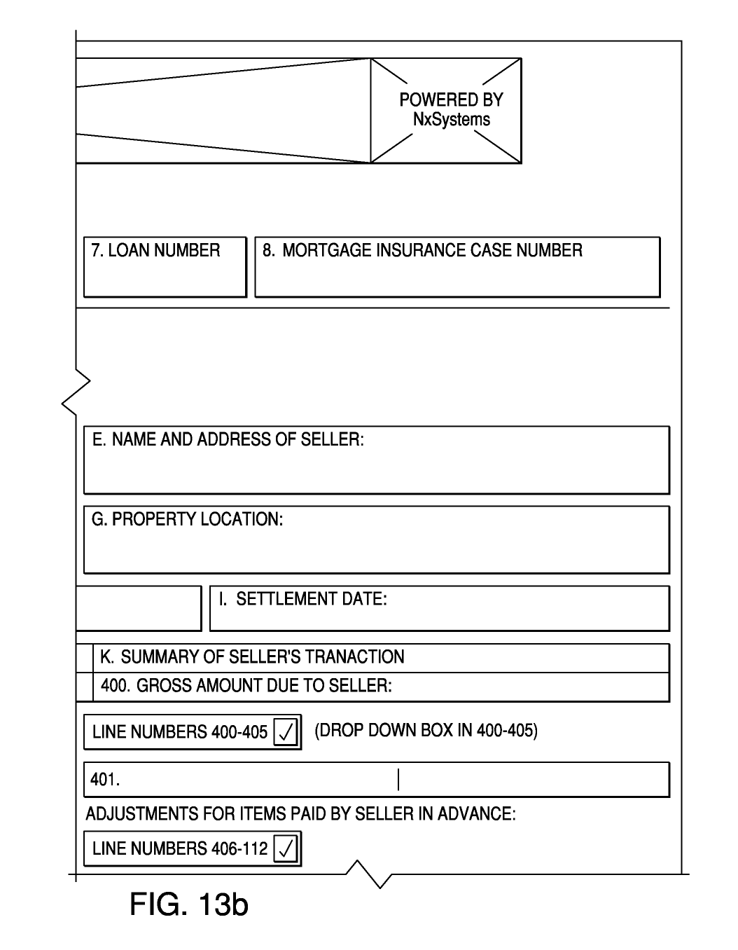

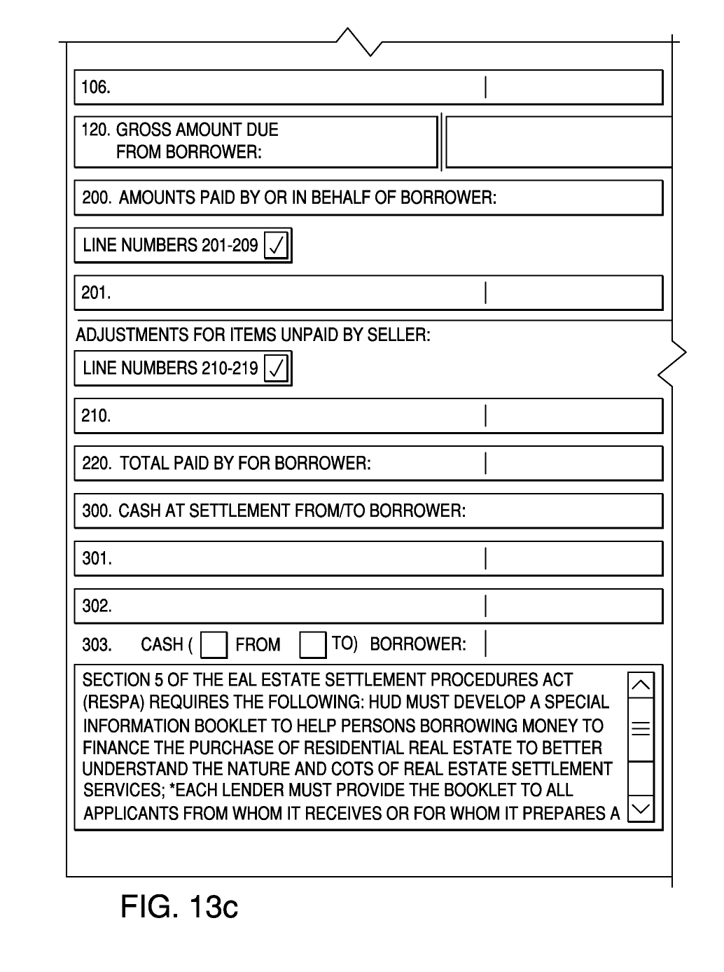

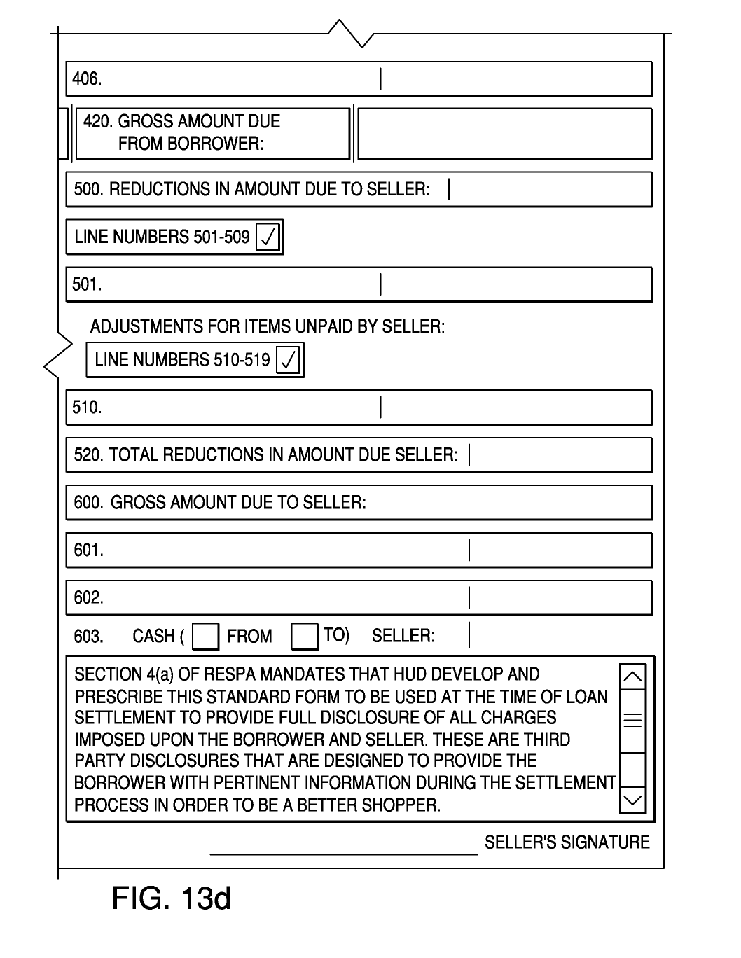

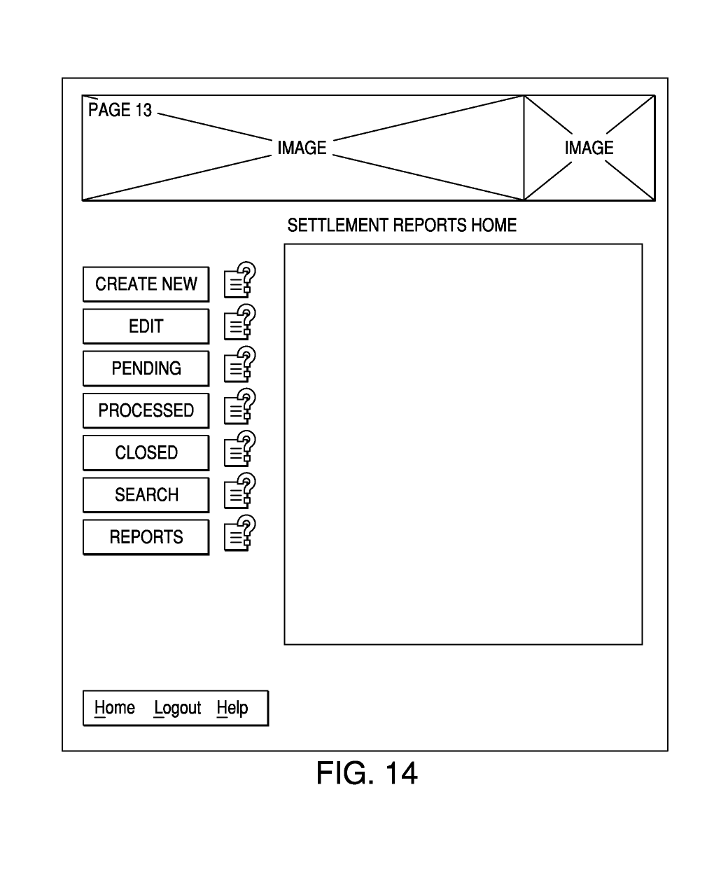

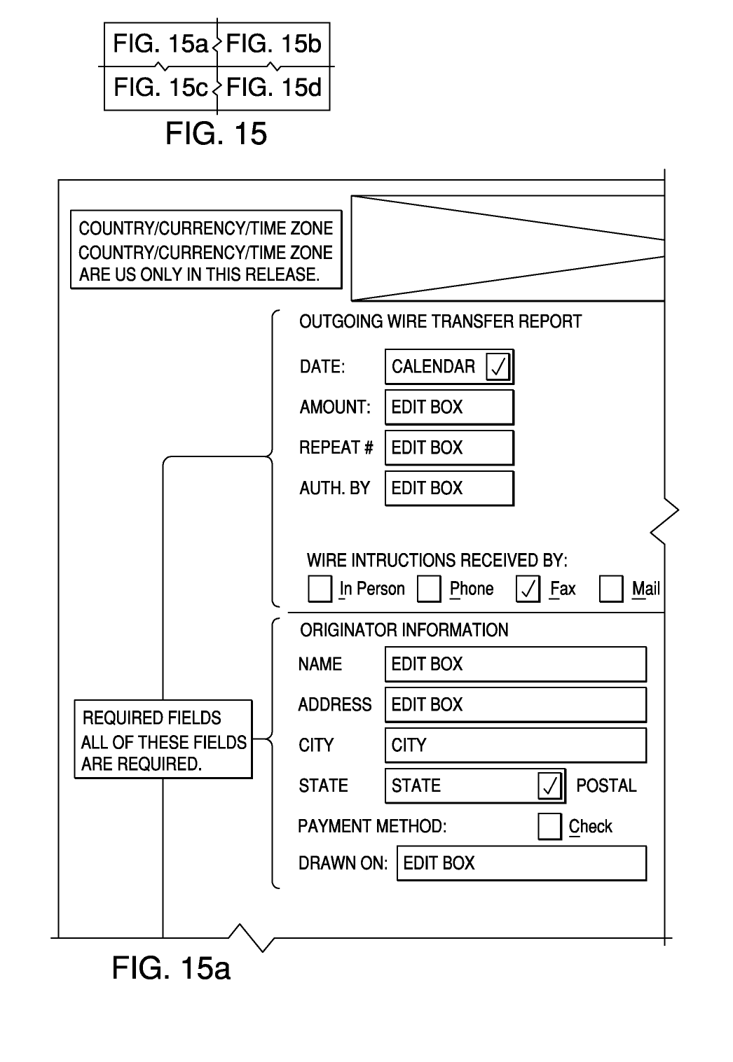

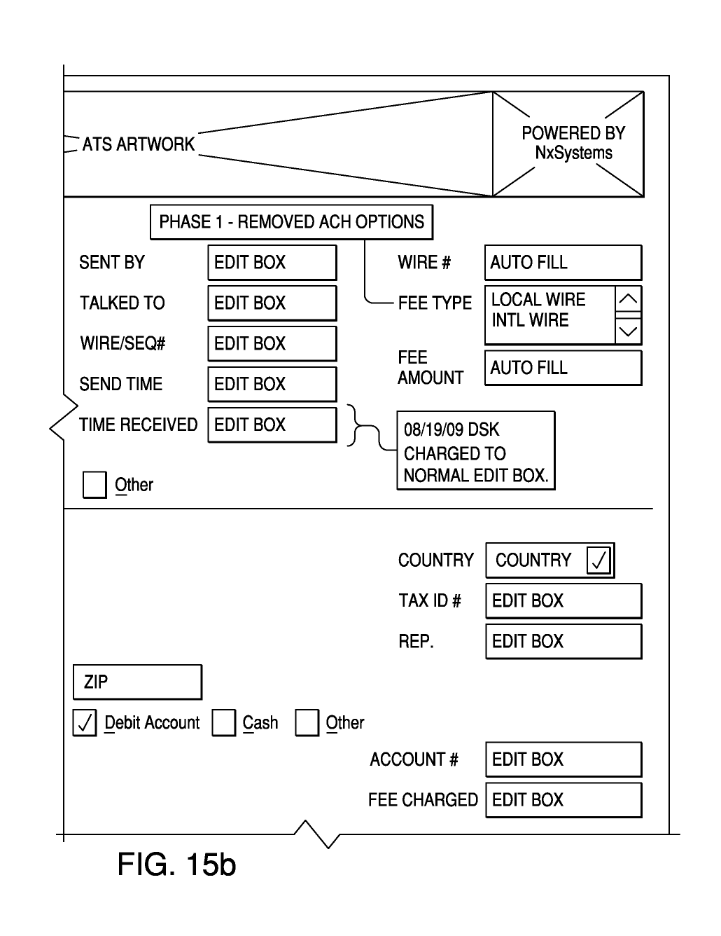

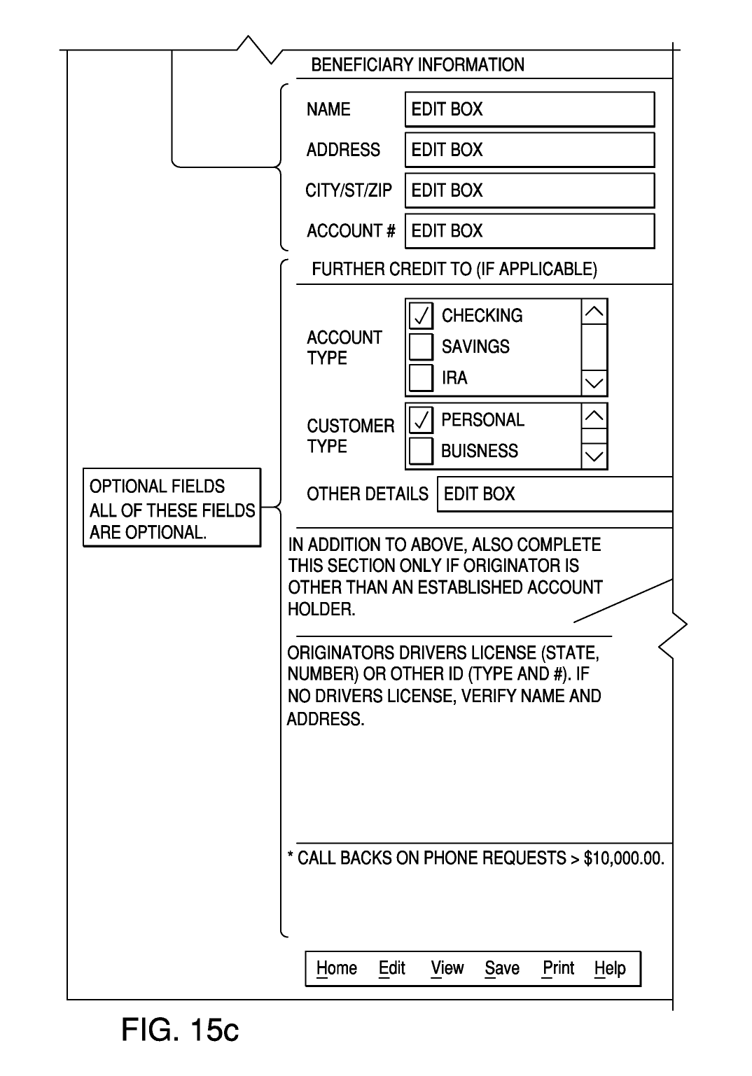

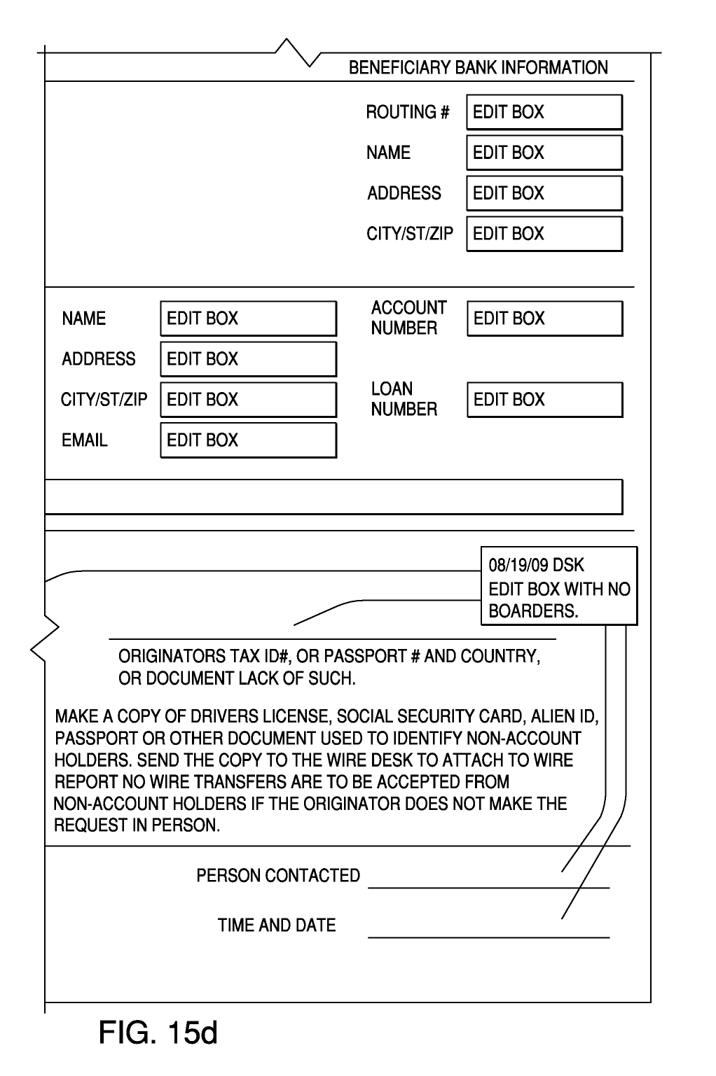

Referring to FIGS. 1-19, the principles, aspects and embodiments of the present inventive concepts provide a system and method for executing global bi-directional electronic payments and distributions, as well as a system and method for tracking, monitoring, and storing various forms of electronic funds in multiple currencies, tokens, and points. In addition, various principles of the present inventive concepts enable a system and method capable of operating as a financial services provider that offers destination accounts for bank accounts and plastic cards and that further enables worldwide processing of macro and micro payments for both incoming and outgoing transactions.

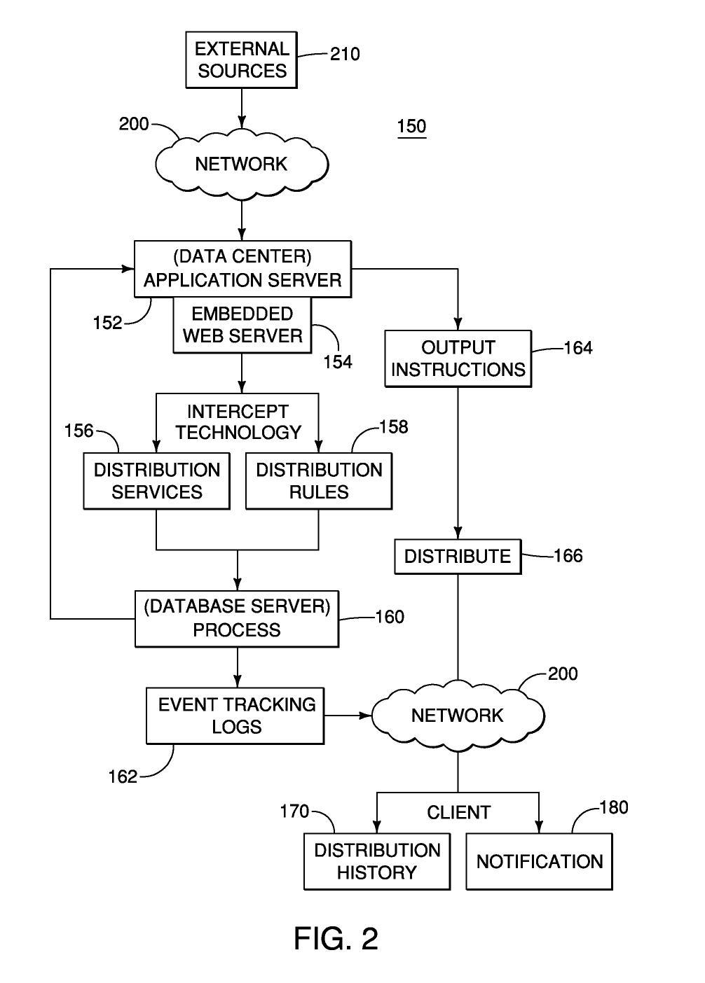

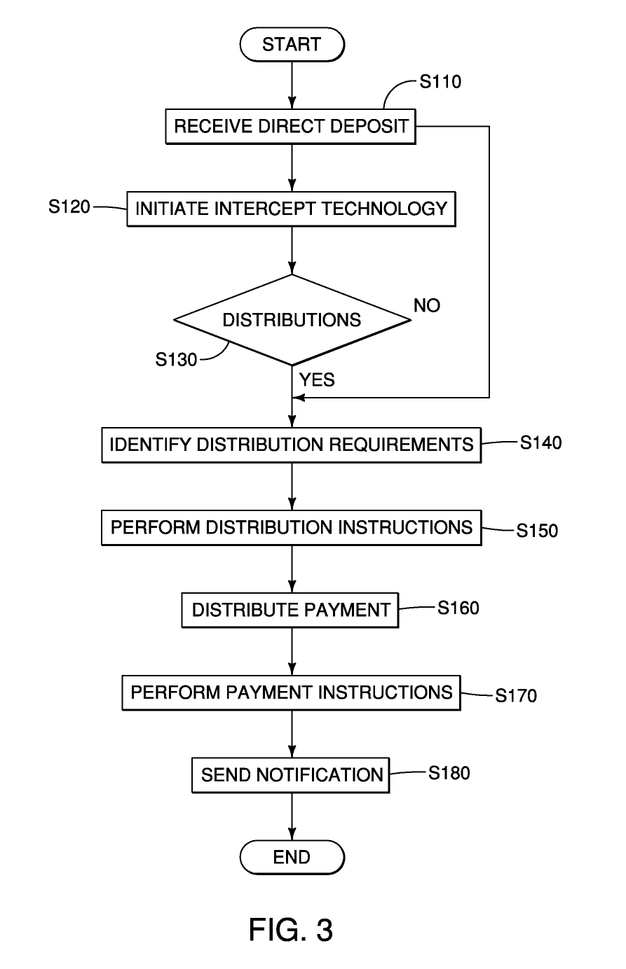

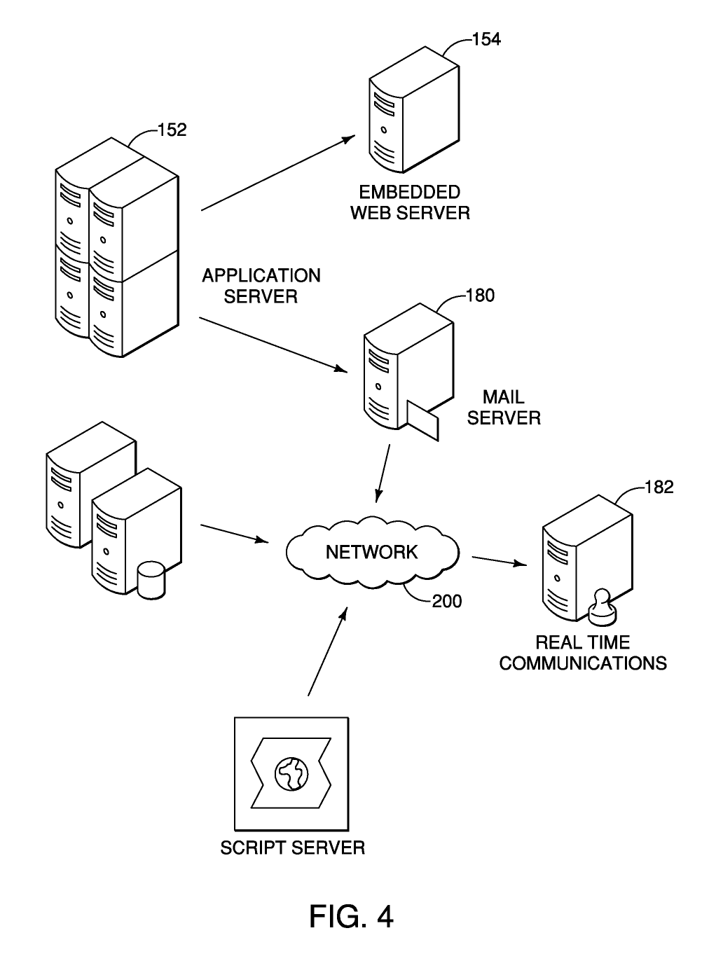

FIG. 1 is a schematic block diagram illustrating certain aspects of a computer-implemented system and method for facilitating electronic funds management and transfers according to various principles of the present inventive concepts. More particularly, in the embodiment of FIG. 1, using Intercept Technology™, funds can preferably be captured, redirected and distributed to user-specified destination subaccounts and/or exit products for the funds before they are deposited in the user's primary account. FIG. 2 is a schematic block diagram detailing various components and operations for capturing and distributing electronic funds transfers with complete tracking capabilities using the electronic funds management and transfer system and method of FIG. 1. FIG. 3 is a schematic block diagram illustrating program logic for establishing and implementing rules and conditions for prioritizing, performing, tracking, and logging transactions and transactional data. FIG. 4 is a schematic illustration of various components of a computing system and environment that can be used to provide the system and method of FIGS. 1-3.

Referring to FIGS. 1-4, a computer-implemented system for facilitating electronic funds transactions and management preferably provides multiple subaccounts for a single entity. Each of the subaccounts can be a different account type or currency, with specific characteristics assigned to that subaccount that are different from other subaccounts for the same entity. According to one aspect of the present inventive concepts, for instance, an Intercept Technology™ hardware/software module or program can be provided and implemented in a computer system for capturing and/or distributing of the funds at any stage of the transaction. The captured funds can be divided and re-distributed to subaccounts under the same or multiple entities before ever being deposited into the main account, providing benefits unique to this platform for global electronic funds transactions.

Referring first to FIG. 3, an electronic financial transaction can begin (S110) by electronically receiving a deposit (e.g., a direct deposit) designated for an account holder. Before depositing those funds into a user's primary account, the computer system can initiate an Intercept Technology™ program (S120) to determine what to do with the incoming funds. The Intercept Technology™ program preferably contains one or more sets of rules for determining how to distribute funds from incoming deposits. If distributions are to be made from the incoming funds, the distribution requirements are determined from the set of rules (S140) and the distribution instructions performed (S150) to distribute the designated payments (S160) into the desired subaccounts, for instance. Any further instructions regarding payments (such as payments from subaccounts) can then be performed (S170) and notifications can be sent (S180) to any designated recipients.

An exemplary structure 100 and system 150 for performing such a method will now be described with further reference to FIGS. 1, 2 and 4. As shown in FIG. 1, a user can access the system and set the rules, for example, through an Internet Agency Application 101. Payments or deposits are received into a payment gateway 110 and then a program 112 is run to apply the pre-established rules to the incoming funds. Based on the rules, the program 112 can distribute the incoming funds into one or more client subaccounts. A portion of the incoming payment can, for instance, be designated for and deposited into a first client subaccount 114a, which can in turn be configured to make payments from that subaccount via one or more outputs (116a, 116b). Another portion of the deposited funds can be designated for and deposited into another client subaccount 114b, which can also be configured to make payments from that subaccount via one or more outputs (116c, 116d). A remainder of the funds in either or both of the client subaccounts can be directed to and deposited into yet another client subaccount 118 or into the user's primary account.

As shown in FIGS. 2 and 4, the system 150 can, for example, include a Data Center with an application server 152 and an embedded web server 154. The application server can receive inputs from external sources 210 through a network 200 (such as the interne or other network). The inputs can, for example, be payments and could also be instructions for distributing incoming payments. As payments come in, the embedded web server 154 can run a distribution services module 156 in the Intercept Technology™ program to determine how to distribute the payments based on the distribution rules 158. Output instructions 164 can be generated to instruct the computer system regarding the appropriate distribution of the funds and the funds can then be distributed by a distribution module 166 again, for instance, through the network 200. A database server 160 can be included to store data related to the transactions and event tracking logs 162 can be generated from the information in the database server 160. A distribution history 170 and notifications can also be provided to the client using a client terminal 182 via the network 200, such as through a mail server 180. Of course, the various servers can be provided in one or more computer systems at one or more locations and the network can include one or more networks such as LANs, WANs, and the internet, for example.

The system preferably accepts direct deposits and other sources of incoming funds, then credits the users' subaccounts with the amount of funds provided to cover transactions. In other words, the system accepts direct deposits and intercepts or captures those funds before deposit into a primary account, and automatically distributes the incoming funds to pre-determined accounts based on preset instructions to accommodate various transactions such as automated bill pay, car payments, utility payments, or funding plastic cards for the account holder or other account holder(s) (e.g., such as a plastic card for college student). This system thereby allows users to make payments to employees or other entities, including bill pay, and is not limited to payouts to specific entities.

In one embodiment, for example, the individual user could be permitted to set up multiple subaccounts, each with different rules and capabilities. One subaccount, for instance, could be set up as a pre-paid debit card that is funded with a certain amount of money every month to provide an allowance for a college student. Another subaccount could be set up as a mortgage account that can be configured to receive a specific amount of money from each paycheck and can be further configured to use that money to electronically pay the mortgage each month. Any number of subaccounts could be set up and configured by the user to perform any desired electronic financial transactions based on the rules established by the user. Each subaccount could further be set up as any desired fund or account type (e.g., prepaid debit card, distribution account, holding account, savings account, checking account, etc.), and can be configured to automatically perform any desired electronic financial transaction in any desired currency based on the specific set of rules established by the user. As another example, for instance, a savings account could be set up to receive and retain a certain amount of money each paycheck, each month, or with each payment that comes in from any source. The power, flexibility, and added security of such a system should be apparent to those skilled in the art.

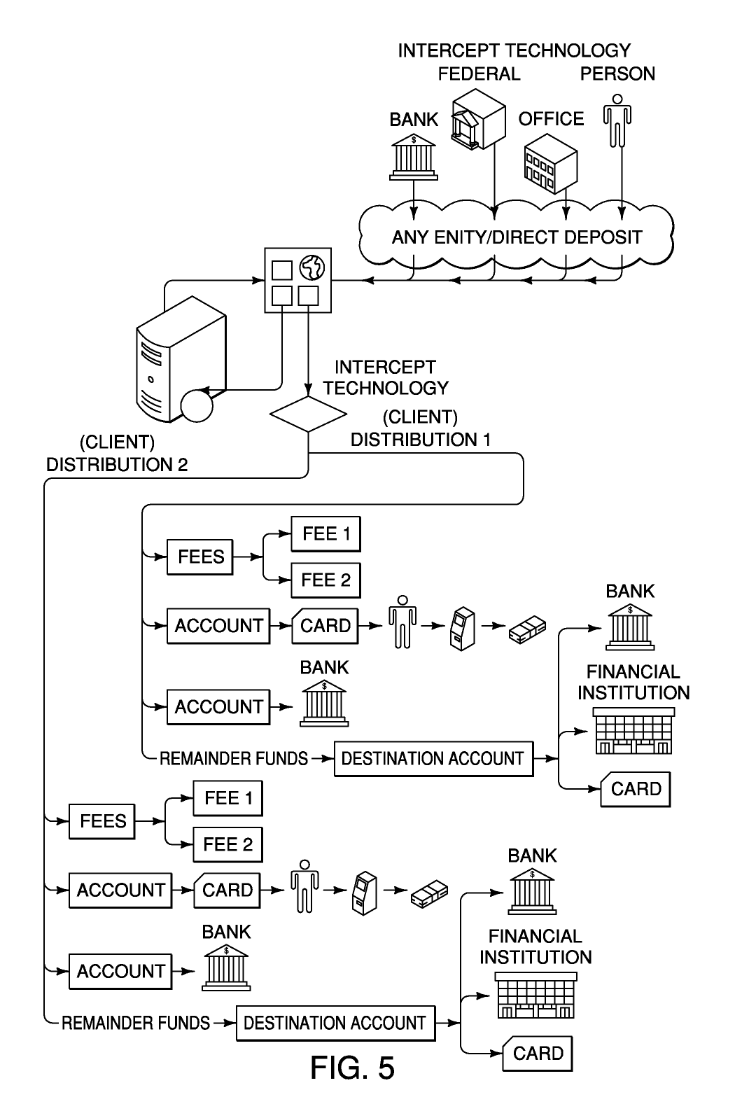

FIG. 5 is a schematic illustration showing one potential implementation of the system and method of FIG. 1. Referring to FIG. 5, a system and method according to principles of the present inventive concepts can be used to perform global electronic funds transactions in which funds can be electronically received and distributed using multiple entry and exit products. Numerous potential intercept and distribution capabilities are provided (including the virtually limitless combinations of processing rules and exit products) for both client and provider distributions.

Using Intercept Technology™ hardware and/or software, the funds can be captured and redistributed before they ever reach the destination account or subaccount, with amounts and redirected destinations set by the account owner or another entity collecting funds as a service for the account holder. The system preferably allows direct deposit capturing and monitored fund redistribution as an alternative to the conventional systems in which funds go directly to a processor and end-user account without any reporting mechanism for the account holder. Using this ability, a destination subaccount holder can create distributions to defer an amount or percent of the funds to another subaccount before the funds reach the primary destination account. These subaccounts can be established, for example, for savings, loading plastic cards, paying bills, or for any other purpose the account holder desires for managing their funds. This ability is not limited to any specific funds management categories.

As explained previously, each of these subaccounts can be independently created with its own set of unique rules, such as to automatically direct funds to another subaccount for each transaction to act as a payment into the system or to automatically sweep funds to a bank account or plastic card as a method to automatically exit the funds when received. Again, the subaccounts are not limited to functions or to these exit services or products. The subaccounts are preferably governed by the program and system rules for that entity or user, along with the general program and system rules, in addition to the subaccount specific properties.

The system can provide programs services and rules that are specially adapted for each individual and/or entity using the system. The system can, for instance, be configured to allow or disallow services for each individual and/or entity based on their specific participation level in the program and their desired features. The system services can maintain funds functions related to loading or withdrawing funds from specific processor platforms, allowing or disallowing features of the platform at specified levels, and can include different levels of permissions. The system programs can therefore allow access to modules and capabilities of the system at any user level, thereby providing a customized solution to system entities and users. The programs are preferably modular in design and are not required to be common to the system as a whole for each user or entity. The programs can allow users to access the system by creating data manually, creating data in a file of specific specifications to upload and be processed by the system, or by application interface code for automated processing of system programs, services, and rules by the user.

More particularly, because the system is preferably permissions based it can allow unique access for each user type and for each user within that type. It can also preferably provide unique access at system, program, rules, features, or group access levels or provide any desired combination of access permissions. The system permissions are not required to be specific to any entity type and each entity can be unique in the types and number of levels of access provided. The system programs can preferably allow the subaccounts to be created with inherited properties from the primary account.

The system programs can also allow for unique access levels to the program to accommodate any number of desired commission levels and amounts, such as for agents and service providers that may have an interest in fees and payments to subaccounts. The system is not limited to any specific levels. Any desired entities can be created with its own unique properties, access levels, permissions, collection and payment amounts, and they need not be tied to the access level properties at the program level.

The system can provide a method for entities to create sub-entities, including but not limited to staff, contacts, users, bank accounts, agents, and distributors with unique permissions and access for the modules as a whole or individually as required. The system can, for instance, create a unique identifier for each sub-entity, allow the entity to create a different identifier specific to their business rules outside of the system, and associate the two identities to be used interchangeably throughout the flow of that sub-entity throughout the system programs, services and rules.

In addition to providing the ability to capture and redirect funds based on user-specified rules, various inventive concepts further permit the charging of fees at any juncture of the transaction. Those fees can be collected and allocated between any number of different entities based on rules set up for those transactions. The system also preferably allows for fees to be charged based on a given service or user type at the system level in addition to specific fees that can be unique to any particular entity or user. The system preferably allows fees to be charged to the source or destination of fund movements (or both), and these fees can be charged and distributed to one or more service providers associated with that entity or user at a predefined amount or percentage, or at a predetermined minimum amount. However, the fee distributions are not limited to a specific entity, amount, or distribution process. The system can therefore preferably accommodate setting fees unique to each entity or user and is not constrained to setting fees at the platform level.

The system and method also preferably provides all of the tracking and reporting required by the entity, including, but not limited to, tax statements and reports. The system reports can, for example, be automatically delivered to the entity electronically, stored on the system for the entity to download manually, be deposited to a file transfer protocol repository, or any combination of the foregoing and other methods. The report delivery format and method is, of course, not limited to any of these options.

The system is also preferably enabled to provide detailed real-time reports for the account holders. These reports can include the time and date of a transaction, transaction amounts, fee amounts, distributions amounts, and any other information the account holder desires to receive. This can include information that the user could not conventionally obtain directly from processors. This information can be vital to an account holder to provide them with the necessary information to address and halt fraudulent transactions and issues as soon as they arise.

The system can also preferably perform foreign currency exchanges on funds, allowing them to exit the system in any currency to worldwide exit products, including, for instance, bank accounts or plastic cards, but is not limited to these exit products.

The system preferably allows funds to exit the distribution system as any desired exit product. These exit products can include, for instance, an Automated Clearing House (ACH) transaction, an electronic funds transfer, a wire transfer, or as bank checks, for example. The principles of the present inventive concepts are not, however, limited to these particular exit products.

The system preferably accepts any type of direct deposits or payments and, as discussed previously, is enabled to capture and redistribute funds to any pre-determined accounts automatically. This fund capture and redistribution can be used, for instance, to accommodate automated bill pay, car payments, utility payments, funding plastic cards for the account holder or other account holder (such as a plastic card for a national or international college student), or any other desired purpose. The system interception and distribution process is not limited to any predefined destination account types, exit services, or products.

The system services also preferably allow the system to communicate with unlimited external processors. These processors may include, but are not limited to, processors for plastic cards, Automated Clearing House, Federal Reserve, Electronic Funds Transfer entities, loading solutions processors. The inventive concepts are, of course, not limited to any specific types of financial processor. The services' connections with these processors preferably allow users to complete transactions that push or pull from financial institutions worldwide, and further preferably can permit conversion from any currency to any other currency.

The system can preferably provide a “good funds” rules based model, with reporting features that can include but are not limited to paystubs and tax statements. In one embodiment, the system does not allow payout of more funds than have been credited to the account, so overdraft is not possible. This good funds model thereby saves fees and eliminates complicated overdraft processes and procedures.

The system can further use rules for services, timers, and velocities (transfers within a specified period of time), along with other rules to control the flow of funds and provide safeguards against fraudulent or illegal transactions. The system further preferably includes additional fraud control on transactions in compliance with national and international compliance requirements. Funds can also be stored in holding accounts, and the system can process both incoming and outgoing funds.

The system programs can include rules to govern funds movement in compliance with the regulations of processors and financial institutions initiated by the system services. These rules are not limited in function and can accommodate all compliance regulations, including, for instance, limiting cash loads, complying with the Anti-Money Laundering Bank Secrecy Act, limiting funds movement to comply with specific requirements for the user's business or risk assessment level, and imposing hold periods on any service. The properties of the rules are preferably hierarchal in access level, with each rule being constrained by the level above, and thereby constraining all of the rules to the base level of the system as a whole if required.

The rules can further limit velocities, including the amount of funds moved in or out of the system per hour, day, week, year; how many times the funds can move in and out of the system per hour, day, week or year; the maximum amount of funds moved per hour, day, week or year; and the minimum of funds moved—each of which can be set at any level. The program rules further preferably allow tracking and automated reporting of unusual activity and can freeze funds movements, transactions or accounts until verification and research is completed. As explained above and further illustrated in the accompanying drawings, the system can be implemented in various forms using one or more server and/or client computer systems and/or processors communicating over a wired or wireless network or internet. Various embodiments may involve locating software components and/or modules of the system in server and/or client computer systems and/or processors in various locations.

A content reference document can include contextual characteristics of global bi-directional electronic payments. The contextual characteristics can identify, for example, the technologies for processing incoming and outgoing funds globally, distribution of these funds within the programs, services and rules governing the actions. Substantially unique modules dictate the actions of transactions specific to the constraints mapped in the services and rules. The individual, indivisible operations succeed or fail as a complete unit and cannot remain in an intermediate state, thereby protecting the integrity of the transaction as a whole. The multiple individual operations linked together can include any combination of the services and rules in the program. A successful transaction within the program provides functions significantly unique to this inventive transaction technology for intercepting and distributing global bi-directional electronic funds.

In terms of the inventive concepts, “funds” are not limited to monetary instruments or negotiable currencies, but can include, for instance, points, credits, tokens, or any other electronic transaction medium.

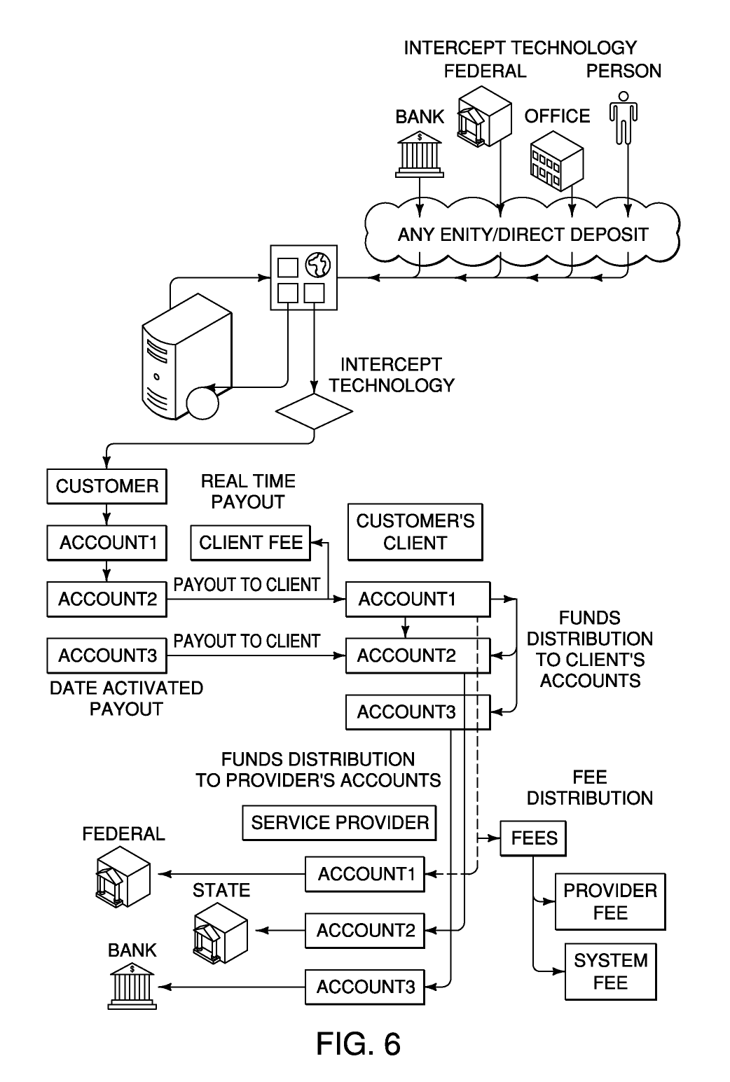

FIG. 6 is a schematic diagram illustrating in more detail various provider distribution capabilities according to various principles of the present inventive concepts. Referring to FIG. 6, a service provider could also be permitted to create distributions on behalf of the destination account holder, such as to provide a tax service where the funds are pooled to a separate account to pay State, Federal, Local and other income taxes. Funds could also be separated and pooled to payout Mortgage closing funds, for instance, with a direct electronic link to the payout entities. Of course, this ability is also not limited to these types of services or service providers. The account holder is preferably provided with the ability to elect to discontinue any distribution services created by the user or a service provider at any time and is preferably further able to recoup any funds not already paid to the recipient entities.

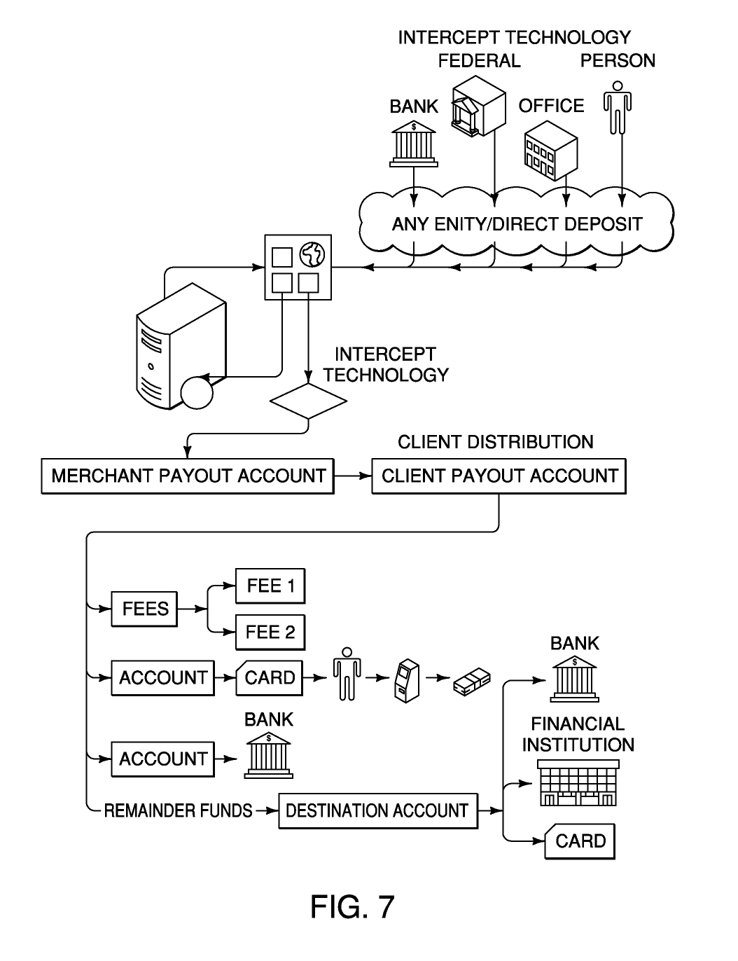

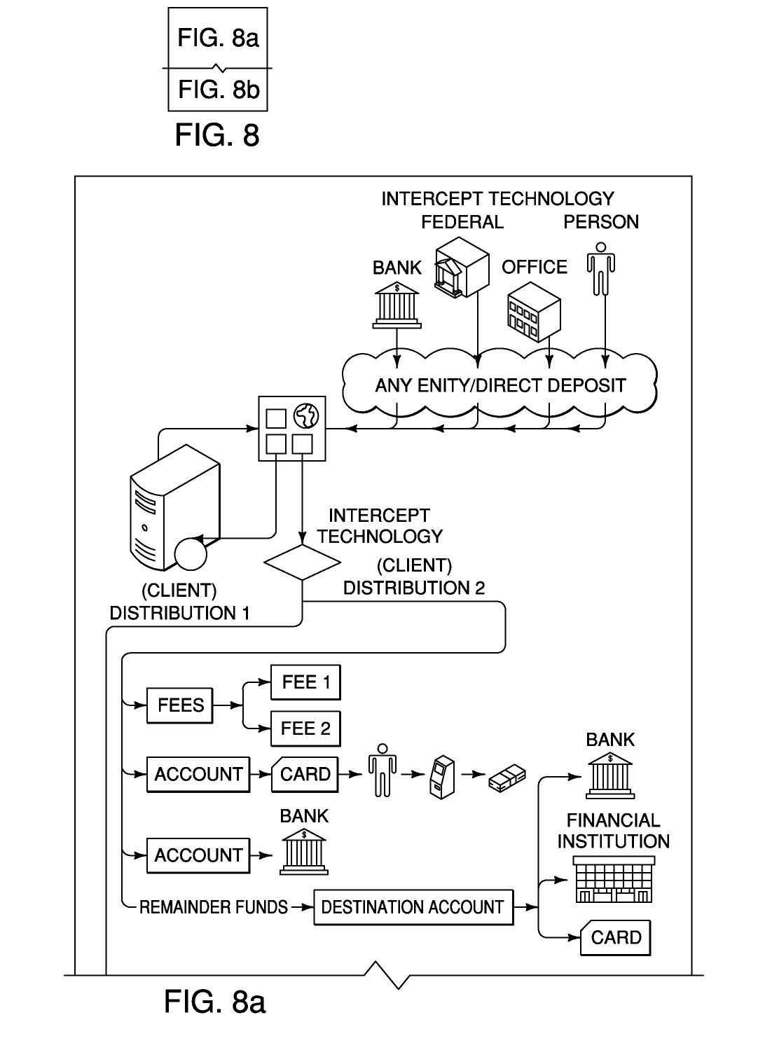

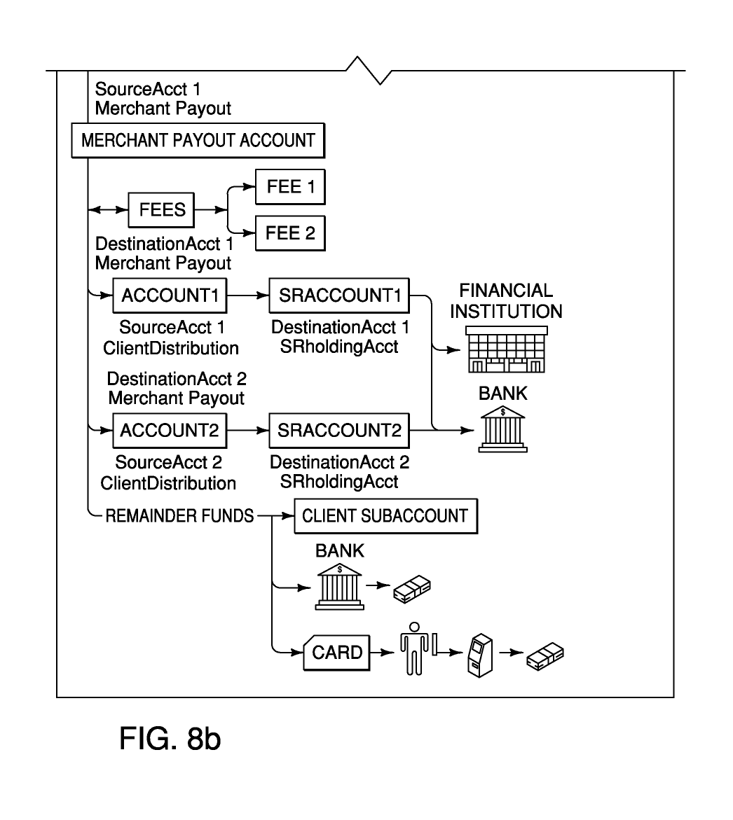

FIG. 7 is a schematic diagram illustrating in more detail various client distribution capabilities according to various principles of the present inventive concepts. FIG. 8 is yet another schematic illustration, showing an alternate implementation of the system of FIG. 1, in which the provider distribution includes a merchant payout account according to additional principles of the present inventive concepts.

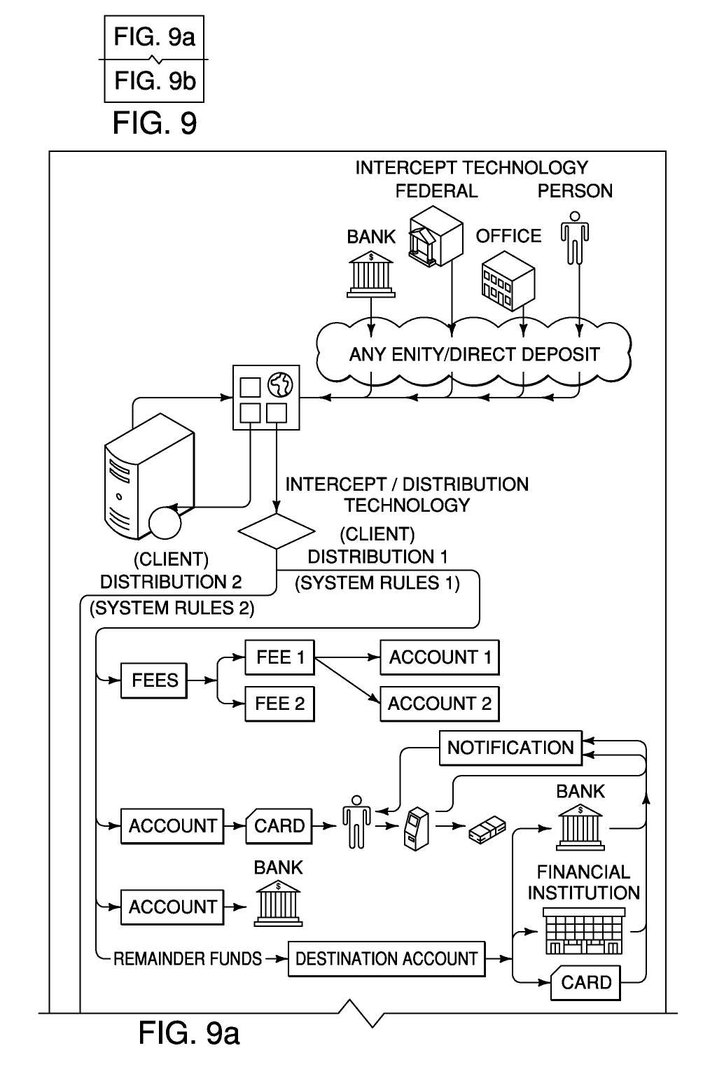

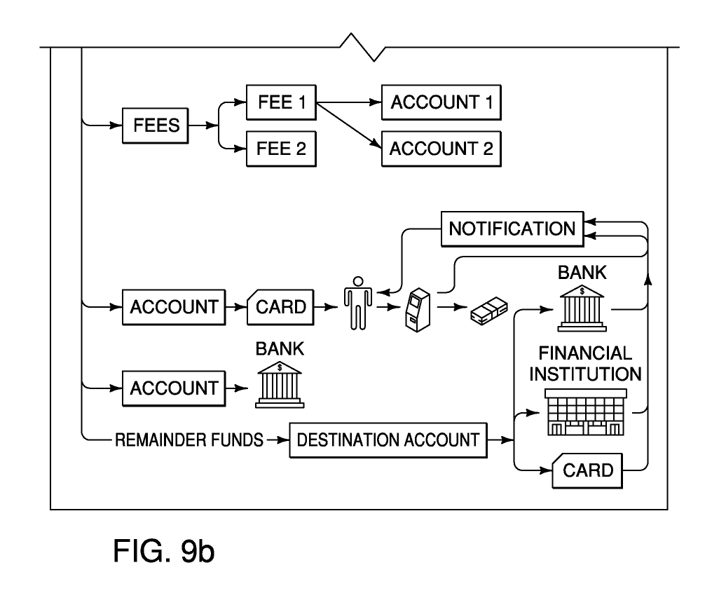

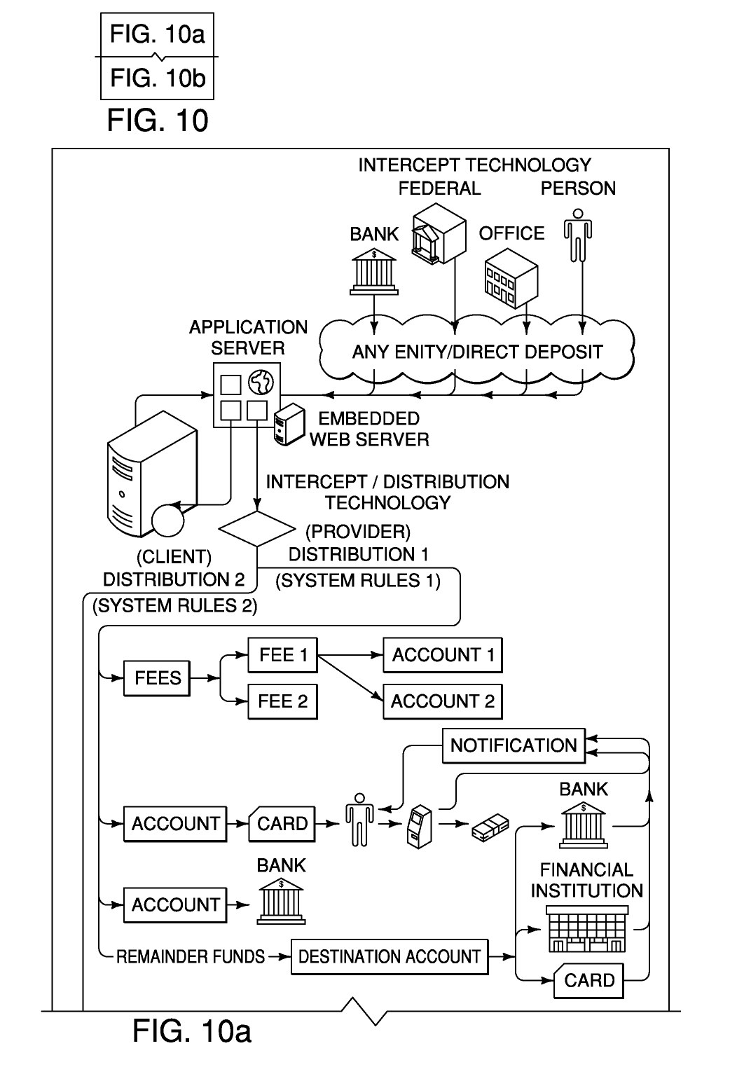

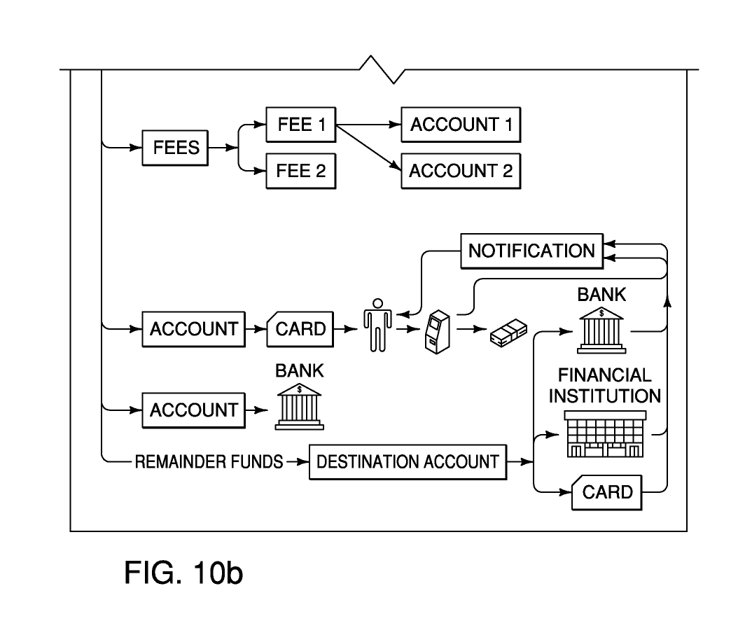

FIGS. 9 and 10 are still further schematic diagrams illustrating some tracking, displaying and notification capabilities of global electronic funds bi-directional transactions according to features and principles of the present inventive concepts. Referring to FIGS. 9 and 10, the system can, for instance, provide users with automatic notification of transactions via electronic mail, short message service (SMS), facsimile, voicemail, or any other desired type of electronic-based notification. The notification options are, of course, not limited to these specific types of notification services. Notifications do not need to be specific to the system programs as a whole and notification parameters can be set at the entity or user level unique to that level.

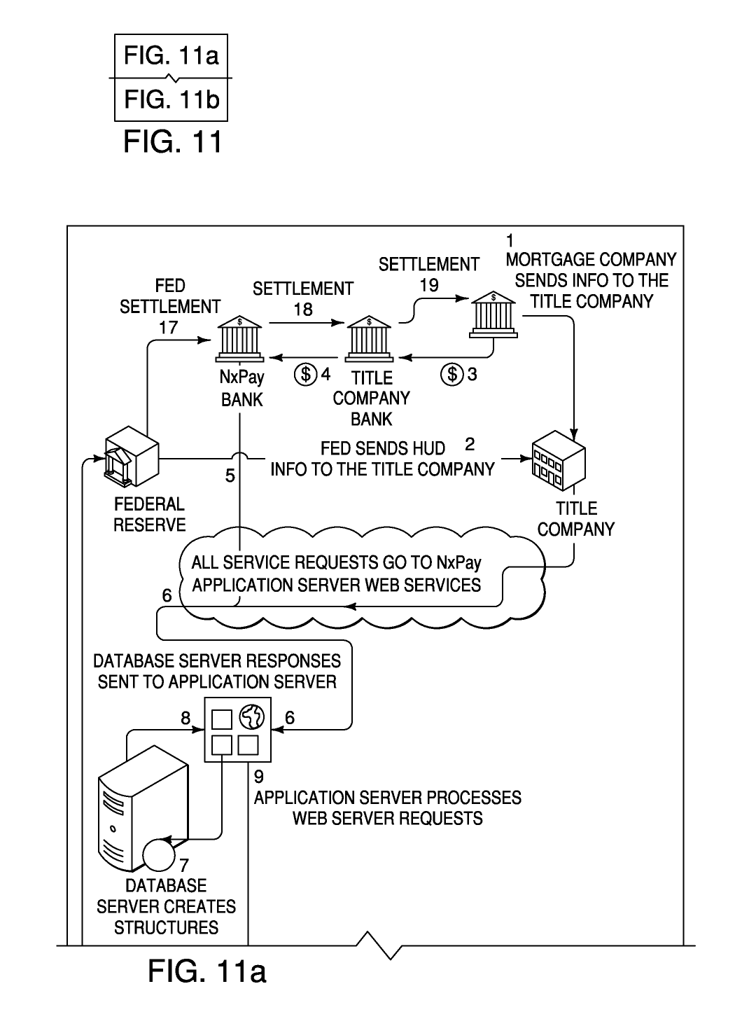

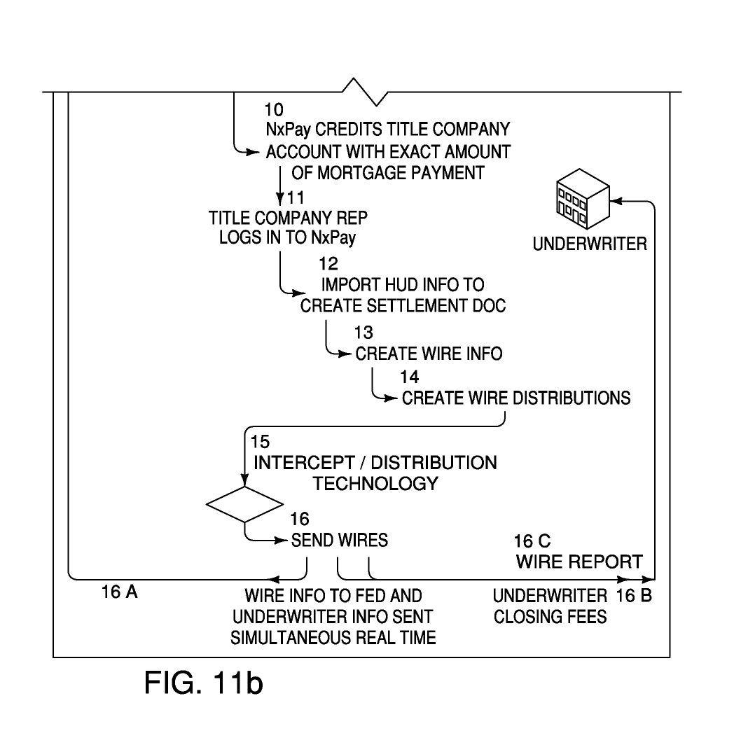

FIG. 11 is a schematic diagram illustrating a system and method for using the features and capabilities of the present inventive concepts to facilitate electronic funds and document transfers for a mortgage closing. Referring to FIG. 11, in one specific embodiment, the receipt and distribution system and process may be used by Title Companies at mortgage closings to receive and distribute funds. The system and process implementing features of these inventive concepts may be used in place of the current cashier's checks system, which is a manual system with unnecessary preparation and delivery costs, delivery time, and other undue delays and expenses. According to this system, the funds can be transmitted, for example, as a wire directly to the Federal Reserve System which allows the funds to be immediately available. The transactions are, of course, not limited to this business model however.

The system can, for instance, use multiple processors, virtual account numbers, card numbers or bank accounts for Direct Deposit of funds and can further provide specific distribution models for payouts conforming to specific requirements used by Title Companies to distribute funds at a mortgage closing, Tax Companies to collect taxes on payroll for self-employed clients, with authorized payment options or pre-authorized automatic transactions. Importantly, the system is not limited to the particular distribution models and requirements of these service types, or to any specific type of process for incoming funds. Rather, the distributions can be set up free form in any desired combination by the individual clients to allow them to budget funds, set up automatic bill pay, or accomplish any other financial objective. Accordingly, the possibilities are not limited to the specific models discussed here.

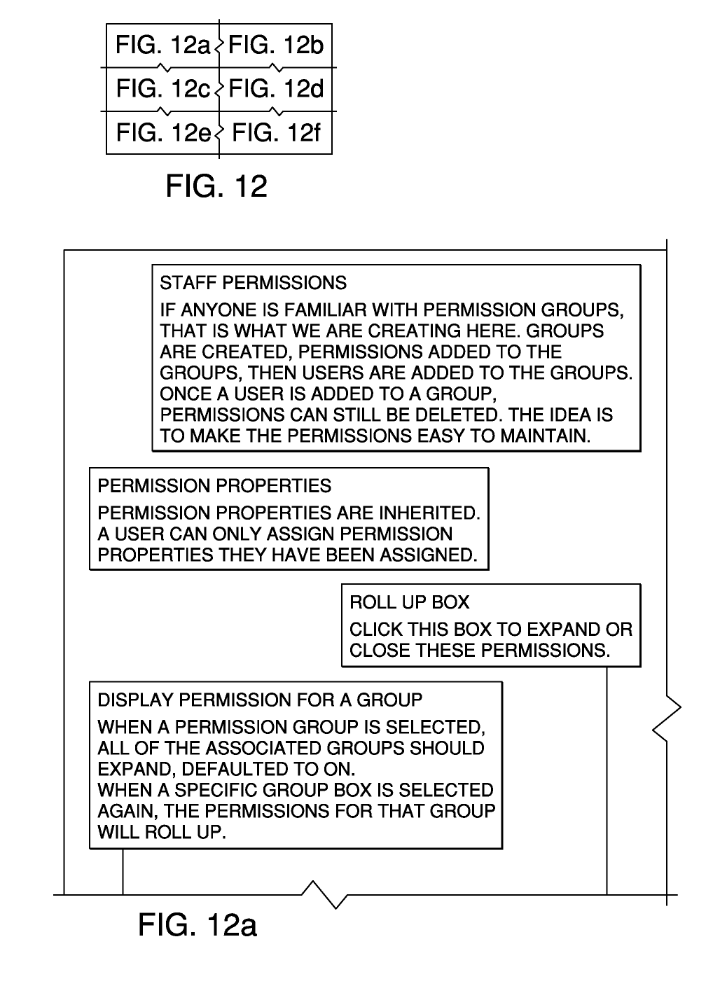

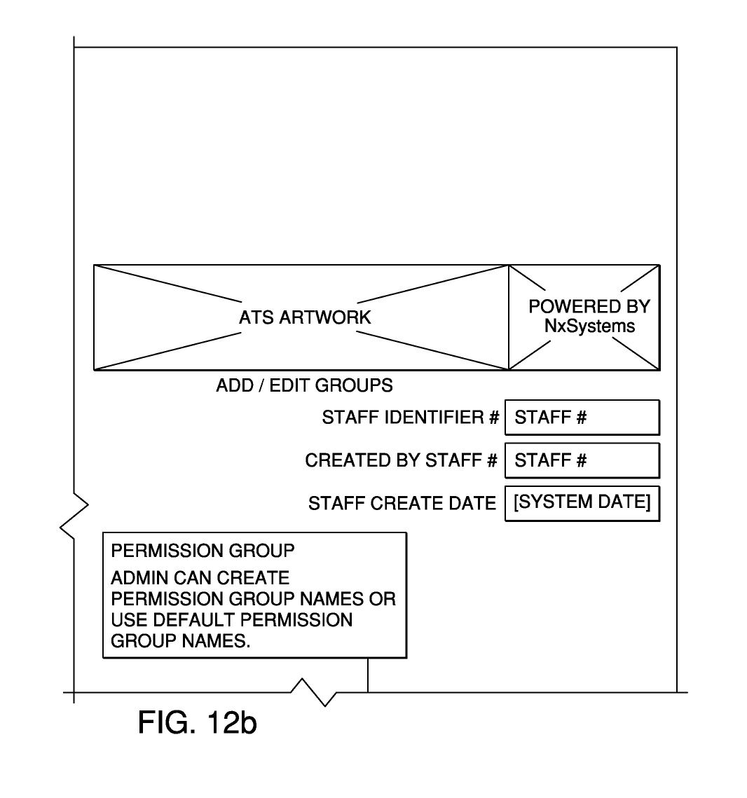

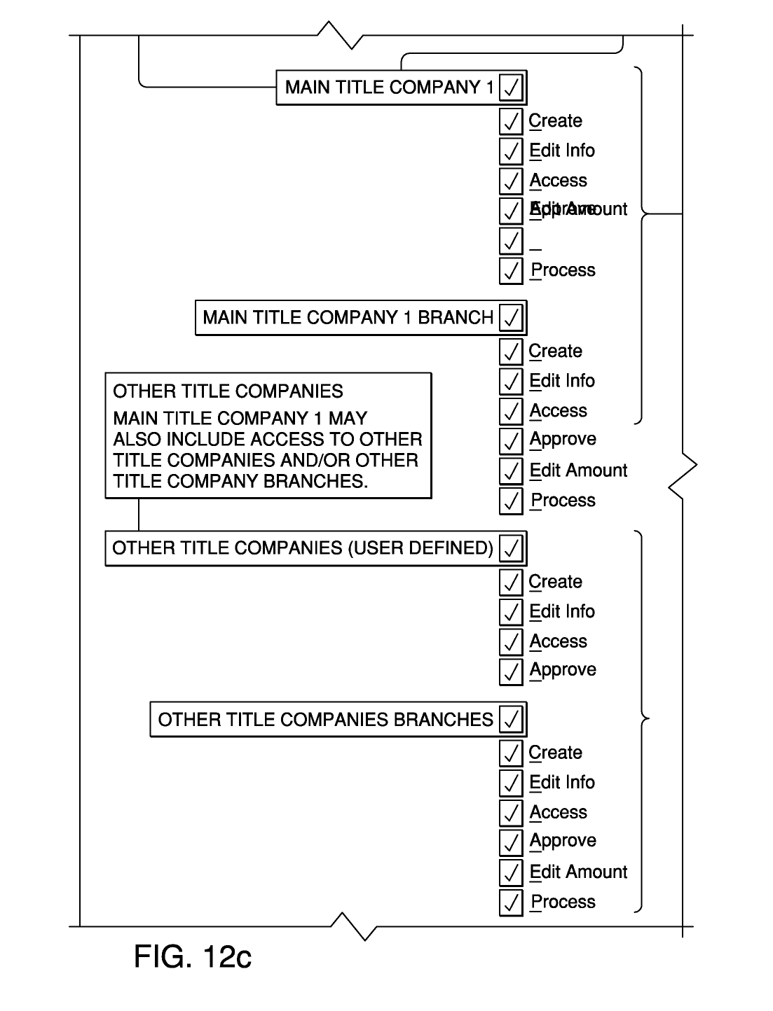

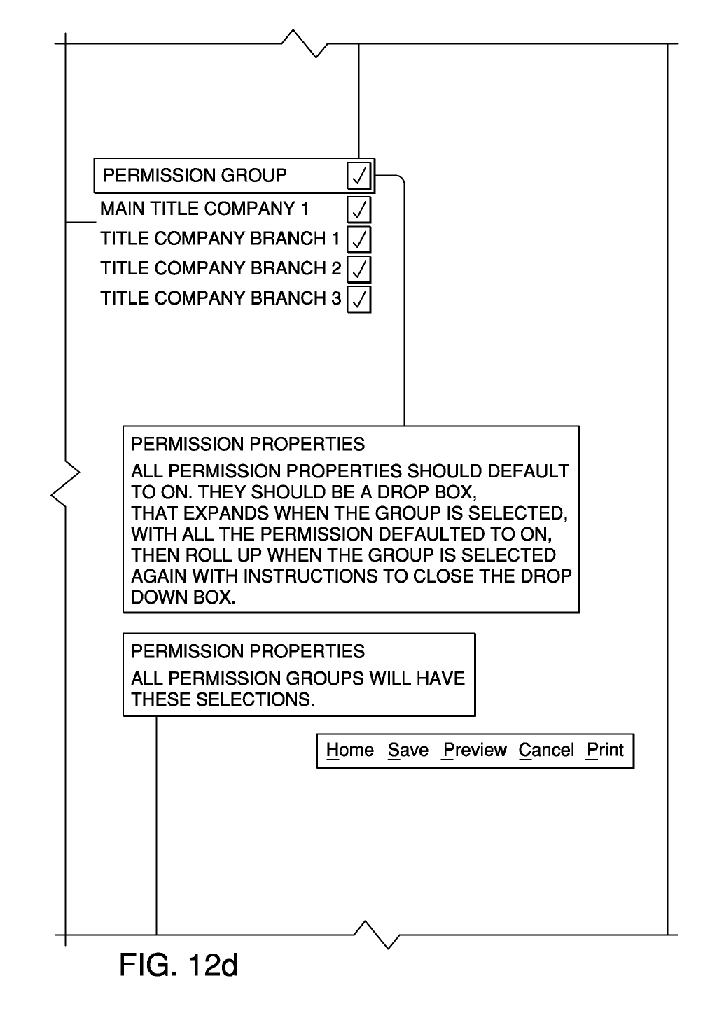

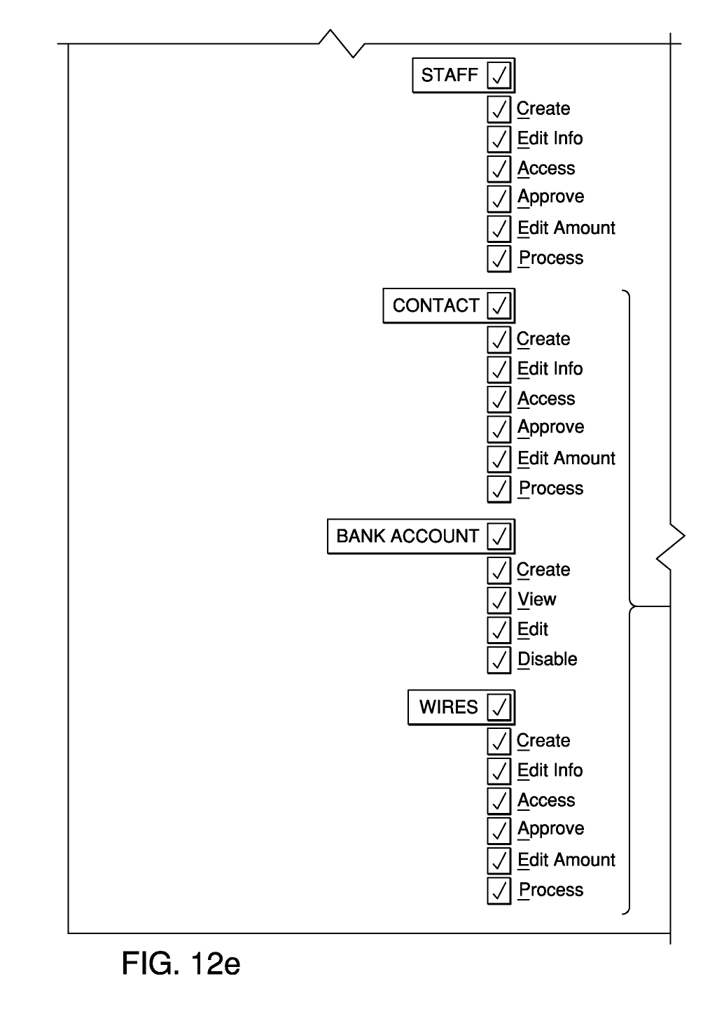

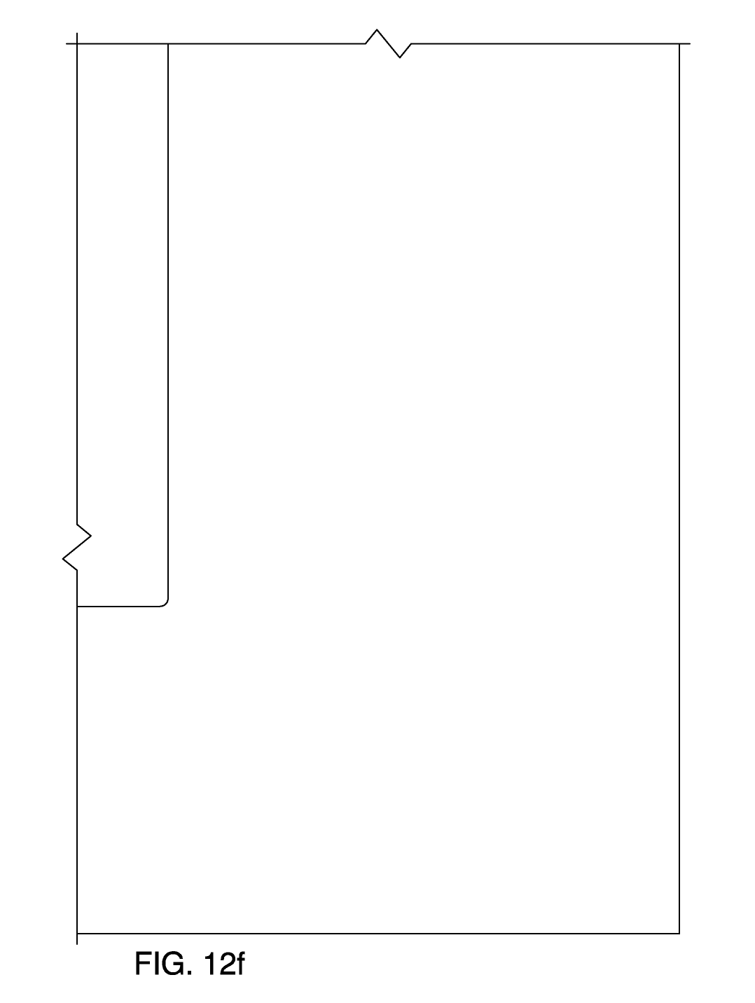

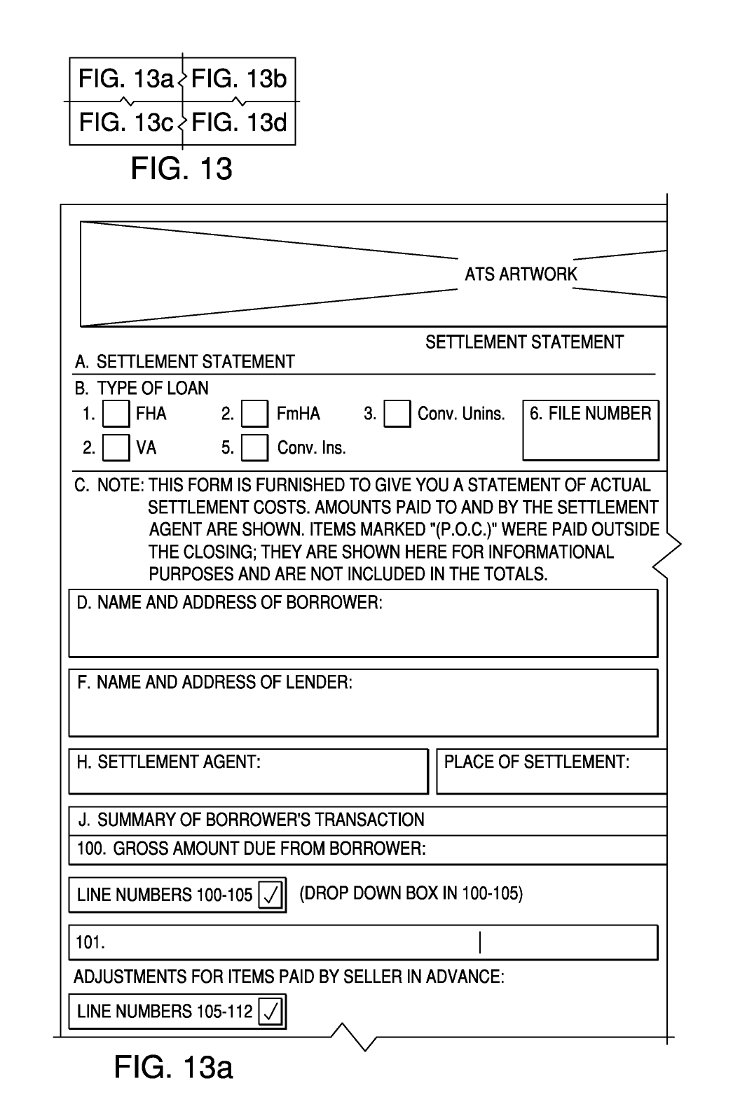

FIGS. 12-15 are various screen shots illustrating a potential interface for receiving input and information from, and communicating information with, a user of a system and method set up to facilitate electronic funds transfers according to various principles of the present inventive concepts. The inventive concepts are, of course, not limited to the particular inputs or interfaces shown in these figures.

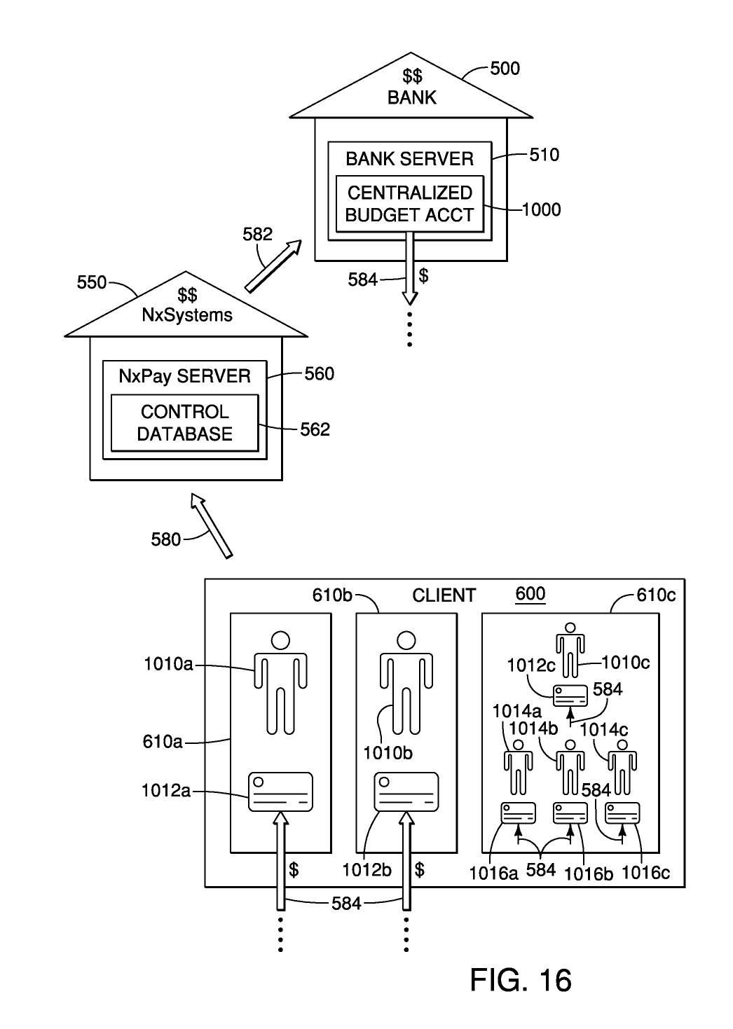

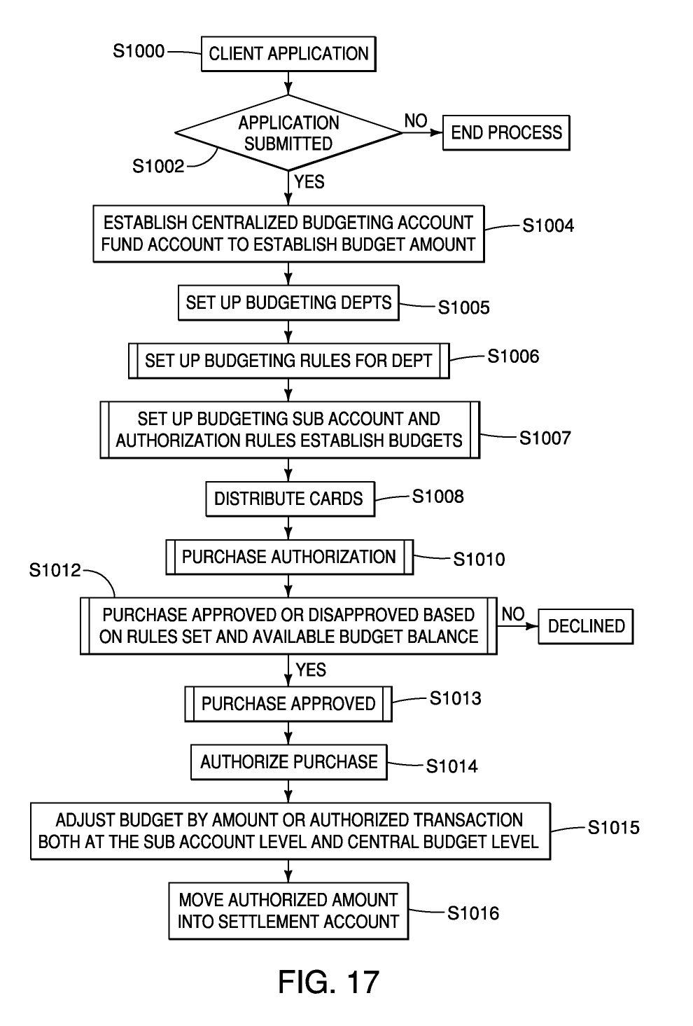

FIG. 16 is a somewhat schematic block diagram illustrating a system and method for creating and managing a centralized budget account according to still other principles of the present inventive concepts. FIG. 17 is a flow chart illustrating a method for creating and managing a centralized budget account according to additional principles of the present inventive concepts.

Centralized Budgeting provides a way for a Client to manage expenditures of a pre-allocated amount of funds (i.e., a budget) in a Central Budget Account, while simultaneously allowing access to those funds, and controlling the spending of those funds, by a number of individuals, departments, organizations, and/or other entities. More specifically, Centralized Budgeting, according to principles of the present inventive concepts, is a program/process that provides a solution to circumstances in which a Client wishes to control expenditures from a budgeted amount of funds, and where there are multiple people/entities (Account Holders) that need to have access to those funds.

Referring to FIG. 16, various entities are preferably involved in the centralized budget account creation and management process. These entities can include, for instance, a client 600 in need of centralized budget accounting and control, a financial institution 500 housing the centralized budget account 1000, and each of the various entities 610 and/or account holders 1010 and subaccount holders 1014 authorized to expend funds from that centralized budget account 1000 based on the predetermined parameters established by the client 600. A service provider/Processor 550 can also be involved, where the service provider can provide a transaction server 560 including a control database 562 that maintains some or all of the rules governing the financial transactions from the centralized budget account 1000. The system process is preferably a reliable, secure, and efficient “good funds” model, which can run, for instance on the Visa/MC network 584. The client 600 can, for instance, use a client computer system, mobile phone, access terminal, or other electronic device (not shown) to access the provider server 560 via a network 580 (e.g., LAN, WAN, or internet). The provider server 560 can in turn communicate with the server 510 of the financial institution via a secure network link 582 (e.g., LAN, WAN, or internet).

In one embodiment, the Processor 550 handles and manages the transactions according to the predetermined guidelines. The Processor 550 is preferably involved in processing the client application for services, in establishing the centralized budgeting account 1000 with a financial institution 500, and in providing account access cards 1012, 1016 for the requested account holders 1010 and subaccount holders 1014, respectively. The Processor 550 can, for instance, be NxSystems, Inc. Electronic financial transaction platform software (such as the NxSystems® NxPay® platform) running on the Processor's server computer(s) 560 and/or the financial institution server 510, can be used to establish the rules for the use of the budget account 1000 and each of the account holder's and subaccount holder's cards 1012, 1016, respectively, as well as to process the day to day transactions based on those rules. The platform software/hardware also preferably allows real time access to information on the use of each of the account holder's and subaccount holder's cards 1012, 1016 and the amount of funds in the centralized budget account 1000.

The account access cards 1012, 1016 can be set up to draw money directly from the Central Budget Account 1000 for authorized transactions, or subaccounts can be established for each of the various account holders/entities and the cards can be set up to draw funds from the respective subaccount. In the case of multiple subaccounts, the subaccounts can be funded in real-time from the Central Budget Account 1000 when a given purchase transaction is authorized.

The system and method for establishing and managing a centralized budget account according to principles of the present inventive concepts provide numerous benefits. In many organizations, multiple people and/or entities need to have access to that organization's funds. Generally, budgets are created to establish how much of those funds are to be used by each of the different people or entities for their specific departments and/or areas of responsibility. However, conventional budget techniques generally rely on each of the individual people or entities to manage their own spending and stay within the budget. Or, they may require complex authorization procedures to access the funds resulting in delays and additional burdens of management. The budgeting system and process of the present inventive concepts allows for the establishment of preset rules and automatic control of spending, with the additional benefit of real-time reporting and/or notifications. The complexities and burdens of managing an organization's budget can therefore be substantially reduced.

The benefits of this aspect of the inventive concepts are therefore particularly beneficial to organizations or entities where multiple people/entities need to have access to the funds in the Centralized Budget Account and where the client needs to monitor expense transactions in real-time. The features also benefit a client that needs to control velocities, dollar amounts, and/or spending categories.

These benefits include substantially increased controllability. Among other things, the centralized budgeting system and method of this embodiment allows a company to monitor spending in real-time; to control who has access to funds; to control where the funds can be spent (defined, for instance, by a MCC (Merchant Category Code), a MTI (Merchant Terminal Ill), or a SKU (Stock Keeping Unit)); to control what the funds are spent on (defined, for instance, by MCC, MTI, SKU); to control when and how often each account access card is reloaded or permitted to draw funds from the centralized budget account, or how often a purchase of a certain type can be made in a given time period (such as within the guidelines of the FI); as well as how much can be spent individually and collectively. The budget can be set and controlled at the client level based on their specific requirements.

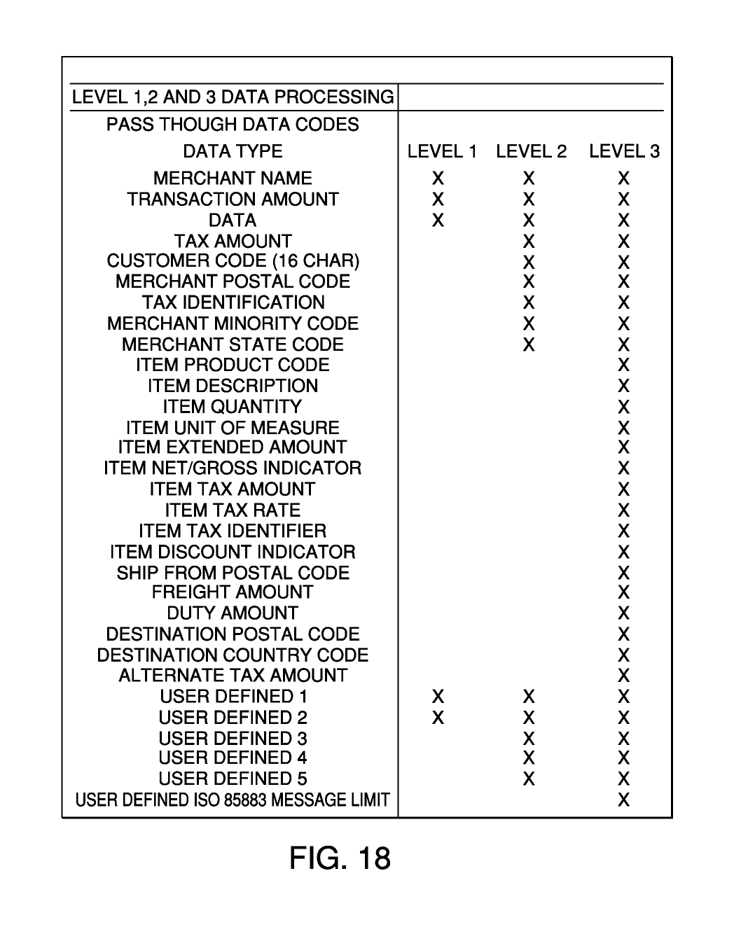

Accordingly, any desired rules/controls can be implemented for each account access card 1012, 1016 issued to control spending from the centralized budget account 1000, including, for instance, discounts for purchases of certain products/services or from certain merchants, controls on timing of purchases, processing of split tender transactions, etc. Any or all of the extended data coming in through authorization requests, for example, could be used to determine whether the required criteria are met for allowing the transaction and for implementing any other desired rules for processing the transaction. Using this data, any desired rules, restrictions, or other purchase transaction parameters could be established for authorizing the transactions, including, but not limited to, rebates, discounts, time of day, product, product type, purchase location, or any calendar or time based event, etc. The table in FIG. 18, for instance, illustrates various data codes and categories that could be used as authorization parameters for any given account holder, card, or transaction.

Another significant benefit of the principles of the present inventive concepts is the speed at which the funds can be accessed and the account can be managed. It is much faster than conventional budget methods. The funds can be distributed over the Visa/MC network, or outside the network via targeted authorization and the transactions are therefore fast, secure, and reliable. From the Client's perspective, the process of setting up an Account Holder and defining a budget for that Account Holder is a nominal number of key stokes. Also from the Account Holder's perspective, the account and/or card can be set up in very little time, and requests for increases in budget, replenishing of funds, etc., can happen almost instantly.

This system and method is also simple to set up and use. The process is streamlined. Each Budget Category can be quickly defined along with other parameters such as dollar limit, time limit, etc., before the card is issued to an Account Holder. The system is also extremely cost effective. Using this system can significantly reduce the personnel needed to manage the budget as well as eliminate check costs and reduce losses due to fraud. And the system is extremely secure. Extensive data reporting can be made available on transactions in real-time and real-time notifications can be provided. The transactions can occur over a secure server environment. The funds are managed in a controlled environment, and numerous checks and balances can be built directly in to the system.

A process for establishing and managing a Central Budget Account according to principles of the inventive concepts will now be described in further detail with additional reference to FIG. 17. To establish a Central Budget Account 1000, a client 600 fills out and submits an application to the Processor 550 and/or financial institution 500 (S1000), and the application is reviewed and either approved or denied (S1002). Once a Client has gone through the approval process and an account is established and funded (S1004), the Client can then set up budgeting departments (S1005) and then utilize the financial platform (e.g., NxPay® system) to define budget rules for each department (e.g., Budget Categories, Limits, Velocities (within guidelines of issuing Financial Institution (“FI”), Number of Account Holders/Cards, a Contact Person for each Card, and/or any other desirable category for controlling and managing the funds in the centralized budget account) (S1006).

Any desired number of subaccounts, along with specific authorization rules and budgets for each of the subaccounts can also be established (S1007). Account access cards 1012, 1016 are then distributed (S1008) to each of the authorized Account Holders, and the Account Holders can then use their unique account access card 1012, 1016 to purchase authorized goods/services (S1010) based on the pre-established budget criteria. Again, as explained above, any desired rules can be established for each account holder/card, including, for example, rules for authorization of the transactions (e.g., time, place, product, amount, etc.), and discounts for shopping at certain locations or buying certain products, etc.

For each attempted transaction (e.g., requested purchase authorization) (S1010), the platform software determines whether the transaction complies with the predetermined rules (S1012). If the transaction complies, the purchase is approved (S1013) and authorized (S1014). Once a purchase is authorized, the budgets are adjusted by the amount of the authorized purchase at both the subaccount and the central budgeting account levels (S1015). The authorized amount can then be moved into a settlement account to fund the purchase transaction (S1016). The settlement account can, for instance, be permitted to draw the approved amount of funds from the Centralized Budget Account 1000 directly, or funds can be transferred from the Centralized Budget Account 1000 to the subaccount associated with the card to make the purchase. Other real-time funding mechanisms are also contemplated as being within the scope of these inventive concepts. And real-time reporting of authorized and/or attempted purchase transactions can further be provided.

In one embodiment, the client 600 can sign up for the centralized budget account 1000 using a Web-based application process. The Contract/agreement can be quickly and easily generated, then signed and submitted to the Processor 550 and/or financial institution 500. Once the client's application is approved, a Central Budget Account 1000 is established along with a corresponding Client Account on the financial transaction (e.g., NxPay) platform, with the Centralized Budget Service enabled on the Client Account. Any desired number of corresponding subaccounts can also be established.

The Client can then build a control database within their Client Account by identifying the various Departments/Groups/Cost Center/etc.; inputting Primary Account Holder information assigned to each Departments/Groups/Cost Center/etc; and defining Secondary Account Holders as needed (either by Client or Primary Account Holder defined by Client). The Client can be permitted to access the Processor servers 560 from their own client computer, mobile phone, PDA, or other electronic device (not shown) to utilize a web-based platform GUI to control the parameters of each account holder's spending authorizations. For instance, by defining limits, velocities, spending categories, etc., for each Account Holder Card or department. Furthermore, everything can be made replicable from parent card, such as in a manner similar to adding a contact in Outlook to Same Company as existing contact.

Once the cards 1012, 1016 are set up and distributed, each Account Holder 1010, 1014 can then purchase the preauthorized goods/services with their card, within the pre-established transaction boundaries. Each transaction is passed through the system and either approved/denied based on those pre-established criteria. If denied, the transaction ends. If approved, funds are debited from the Centralized Budget Account 1000 housed at issuers financial institution 500 and a notification of the purchase can be sent to the client 600 as well as the Primary Account Holders 1010, and/or any other designated recipient for review/audit. The system can, for instance, provide the client 600 and/or Primary Account Holders 1010 with the option to be notified of any purchase, or simply to be provided with a digest or report of transactions over a period of time. This and numerous other options can be defined by the client 600 or Primary Account Holders 1010, for instance.

### Electronic Mass Distribution (EMD)

According to yet another aspect of the present invention, an electronic funds distribution system and method allows any entity, whether a business or individual user, to use the system for all of their funds requirements. For example, a preferred system embodiment can be used to budget funds, pay bills, receive and distribute incoming or outgoing funds to more than one account, pay taxes, and/or exchange currency to engage entities in other countries. It could also be used for collecting bills, disturbing payroll to employees in any country and further permit selection from any of a number of different notifications and reporting formats.

As further explained previously, current electronic funds movement systems have many shortcomings. They may provide an option to facilitate transactions for prepaid debit cards, or provide electronic funds movement between financial institutions, allow users to pay bills electronically, and make or receive payments but do not have a complete solution on one platform. A specific drawback is the inability to have more than one account under their name that has different functions. With the emergence and use of electronic funds movement replacing physical cash and checks, and businesses operating in more than one country, entities need a platform that provides a solution for all of their funds movement requirements, including global payment abilities. An entity also needs a solution that allows multiple electronic accounts, called sub-accounts, with characteristics specific to each sub-account individually and separate from the other sub-accounts. Current platforms allow storing information in an electronic account for a credit card, pre-paid debit card, bank account, but do not allow all forms of payment vehicles to be accessed from one platform.

What is needed is a platform that can accommodate all electronic funds requirements and is capable of incorporating new requirements as they arise. It would be desirable to allow any entity, whether a business or individual user, to use the system for all of their funds requirements, and use the features to budget their funds, pay bills, distribute incoming or outgoing funds to more than one account, pay their taxes, exchange their currency to engage entities in other countries, as well as collecting bills, distributing payroll to employees in any country and select their choice of notifications and reporting formats. It would also be beneficial to have a method of distributing funds to multiple recipients from a single funding source, such as for payroll or disbursement of escrow funds at title closing. Accordingly, a method of distributing funds to multiple recipients from a single funding source can also be provided and is described in further detail below.

The Electronic Mass Distribution (EMD) product provides a way for any global Client to perform a ‘one to many’ distribution of funds utilizing the NxPay platform via the Visa/MC network. The typical user will be a Client that needs to pay multiple people at the same time; either on a transactional basis or as the result of a time based event (i.e., end of month, every Tues., etc). This product can be particularly beneficial to Clients who would like to simplify the process to increase efficiencies and reduce cost, and at the same time be able to pay his/her Disbursement Recipients using ‘good funds’ in significantly less time than is currently the norm.

Various entities are preferably involved in the EMD creation and management process, including an EMD client in need of the system and service. A processor handles and manages the transactions according to the predetermined guidelines. NxSystems, Inc., for example, can be involved in processing the client application for services, in establishing the EMD account and helping set parameters for funds distribution. NxSystems' NxPay® platform can also be used to establish the rules for the distribution of the funds and to initiate the transactions. Because the system can be configured to run on the Visa/MC network, the system is a reliable, secure, and efficient “good funds” model.

Currently, businesses typically distribute funds (such as payroll) to multiple recipients either via check, or through ACH*. Checks are costly, requiring both personnel and natural resources. Additionally, checks are subject to a multitude of delays including delivery of document, clearing of funds, and possible misplacement. Checks can also be intercepted or forged. ACH* or wire transfers eliminate some of those issues, but with the exception of payroll services, no one is offering a ‘one to many’ payment product. In addition, current ACH* or wire transfer only allows the Client to credit funds to the recipients' bank account, whereas the EMD product will allow a client to distribute funds to card products as well.

There are numerous benefits to the EMD system and method of the present invention. Firstly is the speed at which the transaction can occur. EMD is based on a ‘good funds’ model—because the network has verified funds in the originators account, and placed a hold on them, delays are minimized. The funds can further be distributed over the Visa/MC network, and are therefore not subject to time delays like ACH* products are. From the Client's perspective, the process of setting up a Distribution Recipient, and distributing funds to Distribution Recipient is a nominal number of key strokes. From the Distribution Recipient's perspective, the funds are good and immediately available, there is no waiting for check or ACH* clearance.

In addition, the system is simple to use. The process is streamlined and the Distribution Recipient's name, method of payment, and destination are all that's needed to set up a Distribution Recipient in the system. The system is also extremely cost effective—no cost for checks; reduced personnel requirements; there is no postage or other delivery method required; and the fees associated with EMD process are lower than normal wire or ACH* fees.

Furthermore, the system and method is secure. The funds are traceable, reporting is available, and the transactions occur over a secure server environment. The funds are never ‘outside’ of the network, and checks and balances can be built in to the system.

The process and functionality of the system and method according to this embodiment will now be further described. Once a Client has gone through the approval process with NxSystems, Inc, the Client will authorize their financial institution to attach a Visa/MC to the Client's external bank account, in order for funds to be withdrawn out of that account (i.e., a pull) via the Visa/MC network. Then, upon submission of a Distribution Request, and assuming bank balances are adequate, the Client's Financial Institution will issue an Authorization Code. Upon receipt of the Authorization Code, the NxPay® system will distribute the requested funds via a multitude of channels to the Distribution Recipients according to each of the Distribution Recipient's preferences, communicated earlier by the Distribution Recipient to the Client.

The process flow is as follows: The Client signs up for NxPay® program by using their own client computer to access the NxSystems server over the internet. The application process is preferably a web-based application process. Once the application is received and approved, the contract/agreement is generated and sent to the Client for signature. Once the Agreement is signed by Client, the account can be established.

After NxSystems receives the signed Contract and approves the Client, it creates a Client account/program on the NxPay® platform. The EMD Service is then enabled on the appropriate Client account. The Client can then enter a card number attached to source account into NxPay® system (source account may be external account outside of the NxPay® system, housed at financial institution, or internal account on the NxPay® system). The Client then submits information on each of the Distribution Recipients via a web GUI, or via batch submission. The Distribution Recipient information can include, for instance, name, distribution amount, distribution method, destination account (NxPay®, external account). If an external account, fields applicable to that account methodology also need to be provided (i.e., routing number, account number, etc.). Once the information is provided and the pre-transaction requirements have been met, a transaction occurs that triggers the EMD process (i.e., titling for home purchase is complete, payroll period ends, etc.).

The Client can use a web-based GUI to select Distribution Recipient(s) involved in a particular transaction. The distributions can also be configured to be audited by second party of the Client or other service provider (to provide checks and balances). The Client can then submit a request for funds disbursement and the NxPay® System will then contact the Client's Financial Institution via the Visa/MC network for Authorization of the transaction. The Client's Financial Institution then verifies the funds and if funds are available, those funds are placed on hold and the Client's Financial Institution sends NxSystems an Authorization Code. The Client then receives an ‘approved’ notification via the NxPay® GUI. However, if sufficient funds are not available, the Client receives a “Transaction Declined” message.

After the NxPay® system receives Authorization Code from the Client's Financial Institution, the authorized funds settle through the networks to the NxPay® system's external financial institution next day. The NxPay® system then distributes the funds to the Distribution Recipients via each Recipient's chosen method (i.e., ACH* (*ACH would be replaced with appropriate acronym for county of origin), wire, NxPay® Card, NxSystems Pay Any Card®). For ACH transfers, NxSystems creates an ACH* file to be sent to Federal Reserve via NxSystems Financial Institution. For wire transfers, NxSystems creates Wire file to be sent to the NxPay® system's Financial Institution for disbursement. For a NxPay® Card, the funds are credited to Distribution Recipient's NxPay® account. Using the Pay Any Card® system, the funds can be credited to a Distribution Recipient's external credit card(s) attached to their NxPay® account.

Following the distributions, a report of the distribution activity is sent to the Client for review/audit. The total of all funds distributed needs to match what was pulled from the Client source account.

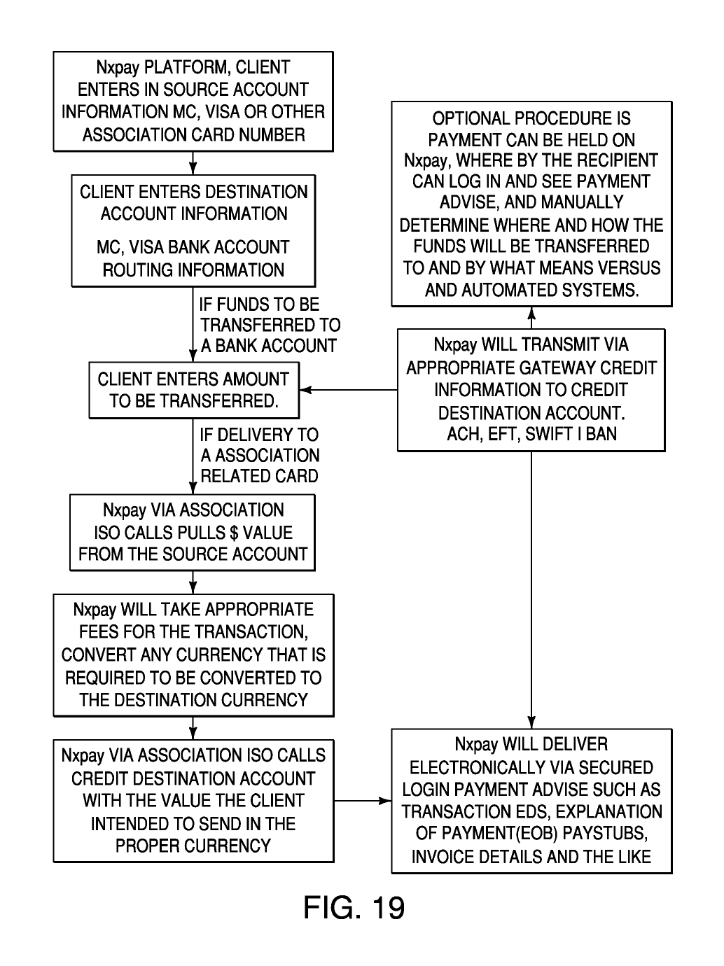

FIG. 19 is a schematic flow diagram illustrating a method for establishing and processing an EMD transaction according to still further principles of the present inventive concepts. Referring specifically to FIG. 19, once a customer has established an account with the service provider, they can set up EMD transactions using the online system. For example, using the NxPay® system, a client sets up an EMD transaction by entering the source account information (which can include, for instance, a Visa, MC, or other association card number). The client then enters destination account information (including, for instance, Visa, MC, or other association card number, or bank account routing information) for each of the desired recipients. The amount for each of the transfers is also entered into the system.

If the payment is to be made to an association related card, card product, or account tied to such a card, then the system preferably both makes the payment and pulls the appropriate amount from the source account using the association ISO calls. In order to understand the contemplated funds transfer transactions, it is important to understand the ISO calls messaging logic. The associations today use ISO calls for card to card transfers, which are different from the calls used for Point Of Sale (or POSA) transactions.

A POSA transaction is used for the purchase of goods and services. POSA transactions typically have a set of fees attached to them which is usually a percentage (%) fee based on merchant type or MCC code. Card to card transfers, on the other hand, can provide a retail product that allows card holders to transfer funds to each other (e.g., remittance). In this particular embodiment, a service provider such as NxSystems can act as a third-party provider, e.g., using the NxPay® platform, to provide commercial applications for the card to card transfer abilities.

In particular, using this system, a service provider can pull funds in real time. This is because Visa, MC and the other associations guarantee the funds in this type of transaction and give real time authorization that the funds are available. The funds can then settle to the service provider the next day. The system can further deduct the appropriate fees from the transaction, as well as handle any necessary foreign currency transactions.

On the out-bound transfer of funds, as with the request for funds authorization, the system preferably uses the same ISO calls, rather than POSA calls, to retransmit those funds to the desired recipient card(s) or other exit products. This provides a real time posting of that transaction. The system can then settle with the association the next day. Incoming funds directly offset outgoing funds in a good funds model. As explained above, in the case of foreign currency transactions, the payment can be credited to the desired account in the proper currency.

If the funds are to be transferred to a bank account, the system will automatically transmit the funds and credit information associated with the transfer via an appropriate gateway (e.g., ACH, eft, SWIFT, Iban, etc.) to the destination account. Optionally, the payment can be held in the system awaiting manual authorization. Using this option, a client can log in and see the payment advice and then manually determine where and how the funds will be transferred.

The same logic can also be used for treasury control to provide for seamless money transfers between bank accounts where an association card (e.g., Visa, MC) is attached to the account. For example, if a customer desires to move monies from one of their US accounts to Barclays in the UK, they can simply transfer funds from the desired US bank account to the desired Barclays account using this method. Depending on the timing of the transactions, the money will show up in the destination account either the same day or the next day as good funds. Once the money shows up in the account, the funds can be ACH transferred, eft wired, or loaded onto a prepaid card.

In either case, along with the transfer, specific additional information can be sent using predetermined fields available for use on the ISO calls. This information can then be set to show up on the customer's bank or other account statement. For instance, the system can provide payment advice for each transaction including, for example, transaction ids, an Explanation of Benefits (EOB), and Explanation of Payment (EOP), a paystub, invoice details, or other desired information.

Having described and illustrated the principles of the inventive concepts with respect to various preferred embodiments thereof, it should be apparent that the inventive concepts can be modified in arrangement and detail without departing from such principles. Numerous modifications of and variations to the foregoing embodiments are possible and will be apparent to those skilled in the art.

What is claimed is:

1. A computerized central budgeting system comprising:
a electronic central budget account belonging to a client and hosted on a computer system of a financial institution, said electronic central budget account containing a quantity of client funds budgeted for use by multiple account holders;
a control database comprising a plurality of rules sets for controlling the distribution of funds from the central budget account;
a plurality of account access cards configured to provide account holders with access to the funds in the centralized budget account, wherein each access card is associated with a set of rules in the control database that controls that card's access to the funds in the central budget account; and
wherein each set of rules comprises rules specifying one or more purchase transaction parameters that govern access to the funds in the central budget account.

2. A computerized central budgeting system according to claim 1, wherein the purchase transaction parameters comprise one or more of spending limits, velocities, purchase categories, purchase locations, and merchants or merchant types.

3. A computerized central budgeting system according to claim 1, further comprising a real-time reporting system configured to provide real-time notification of card transactions to one or more notification recipients.

4. A computerized central budgeting system according to claim 1, wherein the computerized central budgeting system utilizes a good funds model to prevent overdrafting of the central budget account.

5. A computerized central budgeting system according to claim 1, wherein the purchase transactions are configured to take place over a Visa/MC network.

6. A computerized central budgeting system according to claim 5, wherein the purchase parameters comprise one or more parameters corresponding to data codes used for categorizing purchases on the Visa/MC network.

7. A computerized central budgeting system according to claim 1, wherein said access cards comprise one or more primary access cards configured to provide one or more primary account holders with access to funds in the central budget account based on a first set of rules, and further comprise one or more secondary access cards configured to provide one or more secondary account holders with access to funds in the central budget account based on a second set of rules different from the first set of rules.

8. A computerized central budgeting system according to claim 1, wherein said control database is located on a server computer system connected to the internet.

9. A computerized central budgeting system according to claim 8, wherein the control database is configured to be established and/or modified by the client using a user terminal communicating with the server computer system via the internet.

10. A computerized central budgeting system according to claim 9, wherein the server computer system comprises a computerized instruction set configured to provide the user terminal with access to the control database via a web-based interface.

11. A computerized centralized budgeting system, said system comprising:
a primary account electronically funded with a quantity of funds;
one or more non-funded secondary accounts tied to the primary account;
automated budget rules for controlling funding of the one or more secondary accounts from the primary account with funds sufficient for a given purchase transaction, wherein the automated rules provide real-time control over authorization or denial of the given purchase transaction; and
wherein the one or more secondary accounts are configured to receive a quantity of funds equal to an amount required for the given purchase transaction in real-time upon authorization of the given purchase transaction.

12. A computerized central budgeting system according to claim 11, further comprising a first computer system located at a financial institution and housing the primary account.

13. A computerized central budgeting system according to claim 12, further comprising a second computer system located apart from the financial institution, said second computer system comprising a control database containing the automated budget rules for controlling the funding of the one or more secondary accounts from the primary account.

14. A computerized central budgeting system according to claim 13, further comprising a user terminal configured to access the second computer system via the internet and further configured to be able to establish and/or modify the automated budget rules.

15. A computerized central budget system according to claim 11, further comprising a reporting module configured to report information regarding the purchase transactions to one or more designated recipients in real-time.

16. A method of establishing and managing a centralized budget account, said method comprising:
reviewing and approving a client application for a centralized budget account;
establishing a centralized budget account with a financial institution for a client whose application is approved, wherein said centralized budget account contains client funds budgeted for use by one or more account holders;
establishing a set of rules for controlling each account holder's access to the client funds in the centralized budget account;
distributing unique access cards to the account holders, wherein the cards are configured to facilitate the account holder's purchase transactions based on a corresponding set of rules for that account holder; and
wherein each attempted purchase transaction using the access cards is approved or denied in real-time using the corresponding set of established rules.

17. A method according to claim 16, further comprising debiting funds for a purchase transaction from the centralized budget account in real-time once the purchase transaction is approved.

18. A method according to claim 16, further comprising reporting one or more purchase transactions to a designated recipient in real-time.

19. A method according to claim 18, wherein each of the approved purchase transactions are reported to the designated recipient in real-time.

20. A method according to claim 16, further comprising providing the client with real-time access to reports regarding the amount of funds available in the centralized budget account and approved purchase transactions via a web-interface.
